(19) United States
(12) Patent Application Publication
(10) Pub. No.: US 2015/0069106 A1
(43) Pub. Date: Mar. 12, 2015

(54) WEB FOR MAKING FLUID FILLED UNITS

(71) Applicant: Automated Packaging Systems, Inc., Streetsboro, OH (US)

(72) Inventor: Rick Steven Wehrmann, Hudson, OH (US)

(21) Appl. No.: 14/482,706

(22) Filed: Sep. 10, 2014

Related U.S. Application Data
(60) Provisional application No. 61/876,140, filed on Sep. 10, 2013.
(60) Provisional application No. 61/976,546, filed on Apr. 8, 2014.

(51) Int. Cl. B26F 3/02; B32B 3/04

(52) U.S. Cl. CPC B26F 3/02; B32B 3/04; B32B 2250/02; B32B 2439/00; B32B 2553/00
USPC 225/1; 428/35.2; 225/100

(57) ABSTRACT

A web for forming sealed air filled pouches includes a plurality of fold seals that seal first and second elongated layers together along a fold area defining first and second chambers. The fold seals create a cushioned area along a fold area when the first chamber is folded over the second chamber. Also disclosed is a device for separating air filled pouches. The device includes a first stage including a first belt operating at a first speed and a second stage including a second belt operating at a second speed. The web passes through the first stage before passing through the second stage. A pouch is separated from the web at the lines of perforations when a relative speed of the first belt is slower than a speed of the second belt by a predetermined threshold.

### RELATED APPLICATIONS

The present application claims the benefit of U.S. Provisional Patent Application Ser. No. 61/876,140, filed Sep. 10, 2013, and U.S. Provisional Patent Application Ser. No. 61/976,546, filed Apr. 8, 2014, both titled DOUBLE BUBBLE WEB. Provisional application Nos. 61/876,140 and 61/876,546 are incorporated herein by reference in their entirety.

### BACKGROUND

The present invention relates to fluid filled units. It finds particular application in conjunction with plastic webs of interconnected pouches and to processes of converting interconnected pouches to fluid filled units and will be described with particular reference thereto. It will be appreciated, however, that the invention is also amenable to other applications.

Machines for forming and filling sealed air filled pouches from sheets of plastic are known. Machines which produce sealed air filled pouches by inflating preformed pouches in a preformed web are also known. For many applications, machines which utilize preformed webs are preferred.

Typically, the entire length of sides of adjacent sealed air filled pouches formed from a preformed web are connected by perforations. In prior art webs, these perforations extend all the way to an inflation edge of the web.

### SUMMARY

In one aspect of the present invention, a web for forming sealed air filled pouches includes a first elongated layer and a second elongated layer superposed over the first elongated layer. The first and second layers are connected together at an inflation edge and an opposite edge. A plurality of transverse seals extend from the opposite edge to a seal termination point that is a distance from the inflation edge. The inflation edge, the opposite edge, and the transverse seals form a plurality of inflatable pouches. A plurality of fold seals seal the first and second elongated layers together along a fold area defining first and second chambers. The fold seals create a cushioned area along the fold area when the first chamber is folded over the second chamber.

In another aspect of the present invention, a device for separating pouches defined by lines of perforations in a web includes a first stage including a first belt operating at a first speed and a second stage including a second belt operating at a second speed. The web passes through the first stage before passing through the second stage. A pouch is separated from the web at the lines of perforations when a relative speed of the first belt is slower than a speed of the second belt by a predetermined threshold.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic representation of a web for making fluid filled units;

FIG. 2 illustrates a schematic representation of a web for making fluid filled units;

FIG. 2A illustrates a schematic representation of a web for making fluid filled units;

FIG. 3 illustrates a schematic representation of a web with pouches inflated and sealed to form fluid filled units;

FIG. 4 illustrates a schematic representation of a web for making fluid filled units;

FIG. 5 illustrates a schematic representation of a web for making fluid filled units;

FIG. 6 illustrates a schematic representation of a web for making fluid filled units;

FIG. 7A illustrates a schematic representation of a plan view of a process and machine for converting web pouches to fluid filled units;

FIG. 7B illustrates a schematic representation of a plan view of a process and machine for converting web pouches to fluid filled units;

FIG. 8A illustrates a schematic representation of an elevational view of the process and machine for converting web pouches to fluid filled units;

FIG. 8B illustrates a schematic representation of an elevational view of the process and machine for converting web pouches to fluid filled units;

FIG. 9 illustrates a schematic representation of a process for converting web pouches to fluid filled units;

FIG. 10 illustrates a schematic representation of a web for making fluid filled units;

FIG. 10A illustrates a schematic representation of a web for making fluid filled units;

FIG. 11 illustrates a schematic representation of a web of pouches inflated and sealed to form fluid filled units;

FIG. 12 illustrates a schematic representation of a plan view of a cutter for opening the inflation edge of a web;

FIG. 13 illustrates an exemplary embodiment of a web for making fluid filled units;

FIG. 13A illustrates an exemplary embodiment of a of a web for making fluid filled units;

FIG. 13B illustrates an exemplary embodiment of a of a web for making fluid filled units;

FIG. 13C illustrates an exemplary embodiment of a of a web for making fluid filled units;

FIG. 13D illustrates an exemplary embodiment of a of a web for making fluid filled units;

FIG. 13E illustrates an exemplary embodiment of a of a web for making fluid filled units;

FIG. 13F illustrates an exemplary embodiment of a of a web for making fluid filled units;

FIG. 13G illustrates an exemplary embodiment of a of a web for making fluid filled units;

FIG. 14 illustrates a representation of a staggered pattern of internal seals;

FIGS. 15-17 illustrate representations of inflated pouches folded in various stages;

FIG. 18 illustrates a schematic representation of a device for separating the web into individual pouches or sets of the pouches;

FIGS. 19, 20, and 21 illustrate different schematic views of a device for separating the web into individual pouches or sets of the pouches;

FIG. 22 is a flow chart diagram of a process followed by one particular embodiment of the device illustrated in FIGS. 19, 20, and 21;

FIGS. 23-26 illustrate the steps of the process shown in the flow chart diagram in FIG. 22;

FIG. 27 is a flow chart diagram of a process followed by one particular embodiment of the device illustrated in FIGS. 19, 20, and 21; and

FIGS. 28-31 illustrate the steps of the process shown in the flow chart diagram in FIG. 27.

### DETAILED DESCRIPTION OF ILLUSTRATED EMBODIMENT

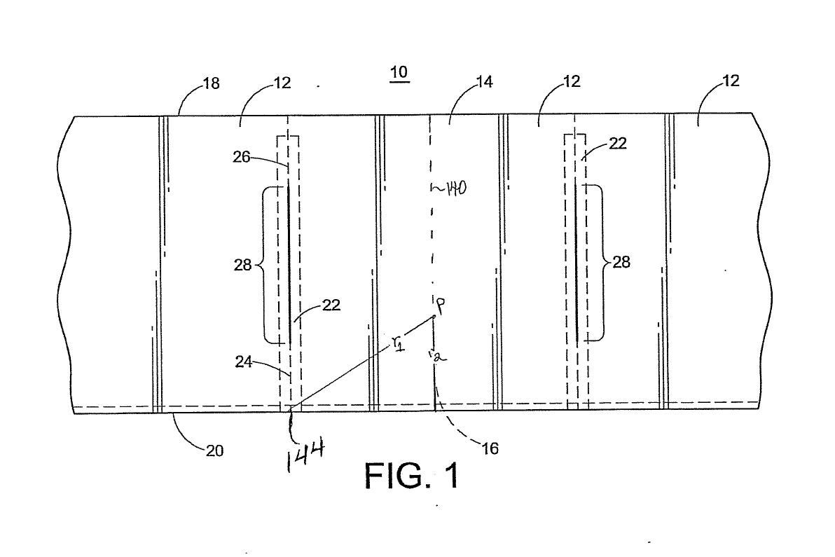

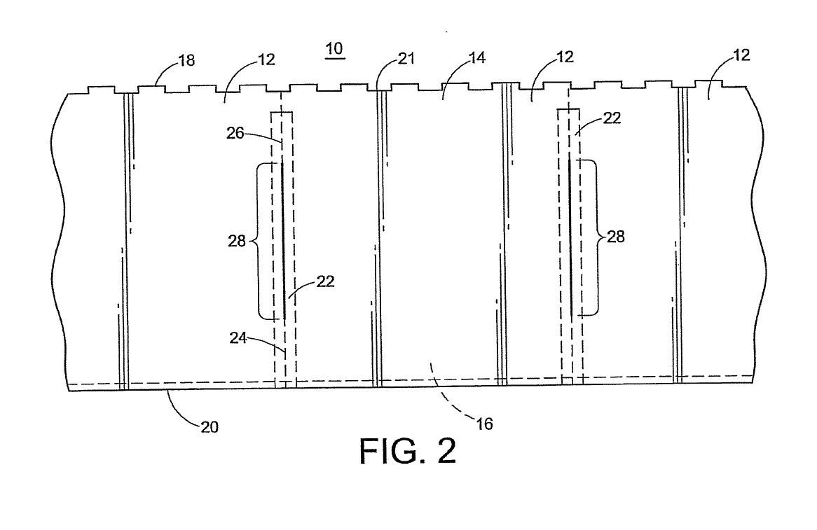

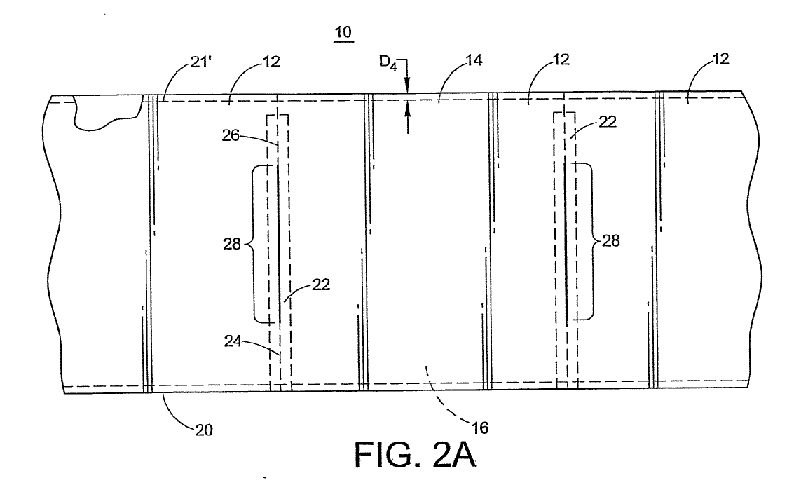

Referring to FIGS. 1 and 2, exemplary illustrations of webs 10 of inflatable pouches 12 are shown. The webs 10 include a top elongated layer of plastic 14 superposed onto a bottom layer of plastic 16. The layers 14, 16 are connected together along spaced edges, referred to as the inflation edge 18 and the opposite edge 20. In the example illustrated by FIG. 1, each of the edges 18, 20 is either a fold or a seal that connects the superposed layers 14, 16 along the edges 18, 20. The connection at the opposite edge 20 is illustrated as a hermetic seal and the connection at the inflation edge 18 is illustrated as a fold in FIG. 1. However, the fold and the seal could be reversed or both of the connections could be seals in the FIG. 1 embodiment.

In the example illustrated by FIG. 2, the inflation edge 18 comprises a frangible connection 21 and the opposite edge 20 is a hermetic seal. The illustrated frangible connection 21 is a line of perforations. The size of the perforations is exaggerated to clarify FIG. 2. The frangible connection 21 may be formed by folding the inflation edge 18 and pulling the inflation edge over a serration forming wheel (not shown). FIG. 2A illustrates a web 10 of inflatable pouches 12 in which a frangible connection 21′ is present in one of the superposed layers, in the described embodiment layer 14, at a location offset from the inflation edge 18 by a distance D4. In an exemplary embodiment, the distance D4 is between about 0.075 inches and about 0.2 inches, in an exemplary embodiment between about 0.09375 inches and about 0.15625 inches. The frangible connection can be formed in a wide variety of different ways any of which can be used. For example, the frangible connection 21′ can be formed by pulling the web over a serration forming wheel (not shown) prior to folding the inflation edge or by providing a serration backing plate (not shown) interposed between the layers where the serration forming wheel contacts the web so that only a single layer is acted on by the wheel.

Referring to FIGS. 1, 2, 2A a plurality of longitudinally spaced, transverse seals 22 join the top and bottom layers 14, 16. Generally, each transverse seal 22 extends from the opposite edge 20 to within a short distance of the inflation edge 18. Spaced pairs of lines of perforations 24, 26 extend through the top and bottom layers terminating a short distance from the edges 18, 20 respectively. A gap forming area 28 extends between each associated pair of lines of perforations 24, 26. The gap forming area 28 opens to form a gap 13 when the pouches are inflated (see FIG. 3).

A gap forming area 28 denotes an area, preferably linear in shape, that will rupture or otherwise separate when exposed to a predetermined inflation force. The magnitude of the inflation force is less than the magnitude of the force needed to rupture or separate the spaced apart lines of perforations 24, 26. The gap forming area 28 can take on a number of embodiments, as will be discussed below. Any method that produces an area between the spaced apart lines of perforations 24, 26 that ruptures or otherwise separates at a force lower than a force needed to rupture or separate spaced lines of perforations 24, 26 may be employed to make the gap forming area 28.

Referring to FIG. 3, the web 10 of pouches 12 (FIGS. 1, 2, 2A) is inflated and sealed to form a row 11 of sealed air filled pouches 12′. The formed sealed air filled pouches 12′ are configured to be much easier to separate from one another than prior art arrays of sealed air filled pouches. In the exemplary embodiment of FIG. 3, each adjacent pair of sealed air filled pouches 12′ is connected together by a pair of spaced apart lines of perforations 24, 26. The spaced apart lines of perforations 24, 26 are spaced apart by a gap 13. A single row 11 of sealed air filled pouches 12′ can be graphically described as being in a “ladder” configuration. This configuration makes separating two adjacent sealed air filled pouches 12′ much easier than separating prior art arrays of dunnage units. To separate a pair of adjacent sealed air filled pouches 12, a worker simply inserts an object or objects, such as a hand or hands, into the gap 13 and pulls one dunnage unit 12′ away from the other dunnage unit 12′. In the alternative, a mechanical system can be used to separate sealed air filled pouches 12′. A machine can be configured to insert an object between adjacent sealed air filled pouches 12′ and apply a force to separate the units

Referring to FIGS. 1-3, prior to conversion to a dunnage unit, a pouch is typically hermetically sealed on three sides, leaving one side open to allow for inflation. Once the pouch is inflated, the inflation opening is hermetically sealed and the dunnage unit is formed. During the inflation process, as the volume of the pouch increases the sides of the pouch have a tendency to draw inward. Drawing the sides of the pouches inward will shorten the length of the sides of the pouch unless the sides of the pouch are constrained. In this application, the term foreshortening refers to the tendency of the length of a pouch side to shorten as the pouch is inflated. In prior art webs, the sides of the pouch are restrained, because sides of adjacent pouches are connected by lines of perforations that extend along the entire length of the pouches and remain intact during and after inflation. The foreshortening of the unrestrained sides, such as the inflation opening, may not be uniform. Restraining the sides of adjacent connected pouches can cause undesirable inflation induced stresses. These undesirable stresses may be caused because sides of adjacent pouches are connected and restrained, thus, limiting inflation and causing wrinkles to develop in the layers at the unrestrained inflation opening. The wrinkles can extend into a section of the inflation opening to be sealed to complete the dunnage unit, which may comprise the seal. One reason the seal can be compromised is that wrinkling can cause sections of the layers 14, 16 to fold on top of one another. A sealing station of a dunnage machine is typically set to apply the appropriate amount of heat to seal two layers of material. The sealing of multiple layers of material in the area of a wrinkle results in a seal that is weaker than remaining seal areas and may result in a small leak or tendency to rupture at loads lower than loads at which the sealed air filled pouches is designed to rupture.

In the embodiment illustrated by FIG. 3, the gap forming area 28, produces a gap 13 between adjacent pouches upon inflation. The gap allows foreshortening of the connected pouch sides and thereby reduces the undesirable stresses that are introduced during inflation as compared with prior art webs. In addition, the web with a gap 13 facilitates fuller inflation of each pouch. The gap 13 maintains the inflation opening substantially free of wrinkles as the inflation opening is sealed to convert the inflated pouches to sealed air filled pouches.

The illustrated web 10 is constructed from a heat sealable plastic film, such as polyethylene. The web 10 is designed to accommodate a process for inflating each pouch 12 in the web to create a row or ladder 11 of sealed air filled pouches 12′. The gap forming area 28 creates a gap 13 between sealed air filled pouches 12′, which facilitate a efficient and effective process for separating adjacent sealed air filled pouches 12′ in the row or ladder 11.

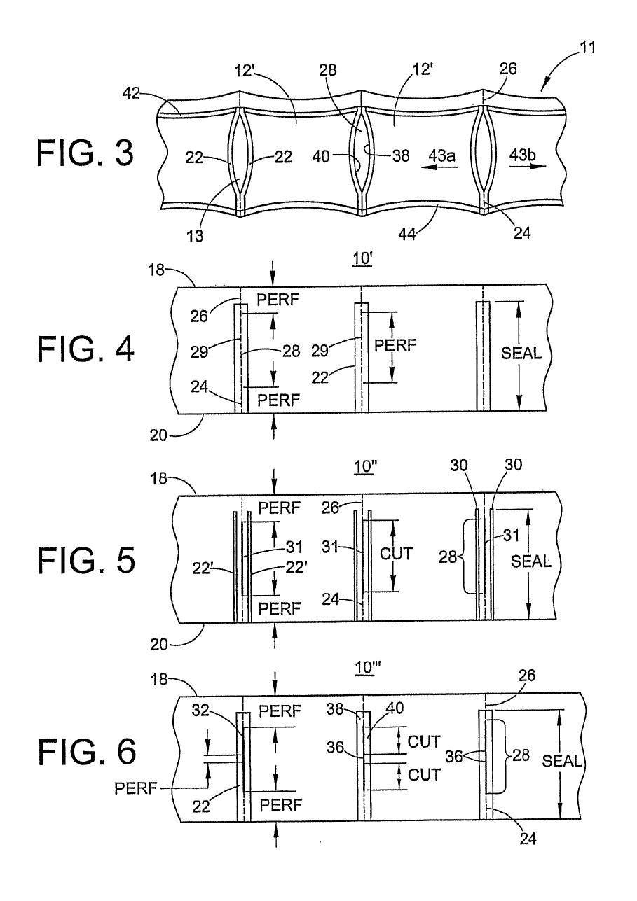

In the example illustrated by FIG. 4, the gap forming area 28 defined by the web 10′ includes an easily breakable line of perforations 29 between the spaced lines of perforations 24, 26. The force needed to rupture or separate the line of perforations 29 is less than the force needed to separate the perforations 24, 26 extending inward of the web edges 18, 20. Each pair of perforations 24, 26 and associated more easily breakable line of perforations 29 divide the transverse seal 22 into two transverse sections. As a pouch 12 is inflated, the line of perforation 29 begins to rupture or separate leading to the development of a gap 13 between the produced sealed air filled pouches 12′ (See FIG. 3). Once the pouch 12 is fully inflated, the line of perforations 29 is fully or nearly fully ruptured; however the perforations 24, 26 at the edges remain intact. These perforations 24, 26 are ruptured or separated when a worker or automated process mechanically separates the perforations 24, 26.

FIG. 5 illustrates another embodiment of the web 10″. In this embodiment the gap forming area 28 comprises an elongated cut 31 through both layers of material 14, 16. The cut 31 extends between each associated pair of lines of perforations 24, 26. In the embodiment illustrated by FIG. 5, pairs 30 of transverse seals 22′ extend from the opposite edge 20 to within a short distance of the inflation edge 18. Each of the pairs of lines of perforations 24, 26 and corresponding cuts 31 are between an associated pair of transverse seals 30. It should be readily apparent that the seal 22 shown in FIG. 4 could be used with the cut 31 shown in FIG. 5. It should also be readily apparent that the line of perforations shown in FIG. 4 could be used with the transverse seals 22′ shown in FIG. 5. It should be additionally apparent that any gap forming area 28 can be used with either of the transverse seal configurations 22, 22′ shown in FIGS. 4 and 5.

FIG. 6 illustrates a further embodiment of the web 10′″. In this embodiment, the gap forming area 28 comprises at least two elongated cuts 32, separated by light connections of plastic 36, also referred to as “ticks.” These connections 36 hold transverse edges 38, 40 of the pouches 12 together to ease handling of the web 10, such as handling required during installation of the web 10 into a dunnage machine. As the pouches 12 are inflated, the connections 36 rupture or otherwise break resulting in a gap 13 between the spaced pairs of perforations 24, 26. This gap 13 allows for full inflation and reduces the stresses in the layers at the seal site normally caused by the foreshortening and restrictions on foreshortening of webs in the prior art. The reduced stress in the layers inhibits wrinkles along the inflation opening to be sealed.

Other methods of creating a gap forming area not specifically disclosed are with the scope of the present application. Any area that separates and forms a gap between adjacent pouches as pouches 12 in a web 10 are inflated are contemplated by this disclosure.

FIG. 3, illustrates a length of the web 10, 10′, 10″ or 10′″ after it has been inflated and sealed to form sealed air filled pouches 12′. An inflation seal 42, the transverse seals 22 and an opposite edge seal 44 hermetically seal the top and bottom layers. The side edges 38, 40 of the formed sealed air filled pouches are separated to form a gap 13. Each pair of adjacent sealed air filled pouches 12′ are connected together by the pair of spaced apart lines of perforations 24, 26. The gap 13 extends between the pair of spaced apart lines of perforations 24, 26. The array of sealed air filled pouches 12′ is a single row of sealed air filled pouches in a “ladder” configuration. The lines of perforations 24, 26 are configured to be easily breakable by a worker or automated system. To separate a pair of adjacent units 12′, a worker inserts an object, such as the worker's hand or hands into the gap 13. The worker then grasps one or both of the adjacent sealed air filled pouches 12′ and pulls the adjacent sealed air filled pouches 12′ relatively apart as indicated by arrows 43a, 43b. The lines of perforation 24, 26 rupture or otherwise separate and the two adjacent sealed air filled pouches 12′ are separated. The existence of the gap 13 also results in reduced stresses in the area of the inflation seal 42 at the time of sealing and accommodates increased inflation volume of the sealed air filled pouches 12′ as compared with prior inflated sealed air filled pouches.

In one embodiment, the line of perforations 24 that extends from the opposite edge 20 is omitted. In this embodiment, the gap forming area 28 extends from the inflation edge line of perforations 26 to the opposite edge. In this embodiment, the gap 13 extends from the inflation edge line of perforations 26 to the opposite edge 20.

The connection of the layers 14, 16 at the inflation edge 18 can be any connection that is maintained between layers 14, 16 prior to the web 10 being processed to create sealed air filled pouches 12′. In the embodiment illustrated by FIGS. 1 and 2A, the connection is a fold. In the embodiment illustrated by FIG. 2, the connection is a line of perforations 21. One method of producing such a web is to fold a continuous layer of plastic onto itself and create a fold at what is to become the inflation edge 18. A tool can be placed in contact with the fold to create a line of perforation. The opposite edge 20 can be hermetically sealed and the transverse hermetic seals 22 can be added along with the separated lines of perforations 24, 26 extending inward from the inflation and opposite edges 18, 20. The web shown in FIG. 1 can be produced in the same manner, except the perforations are not added.

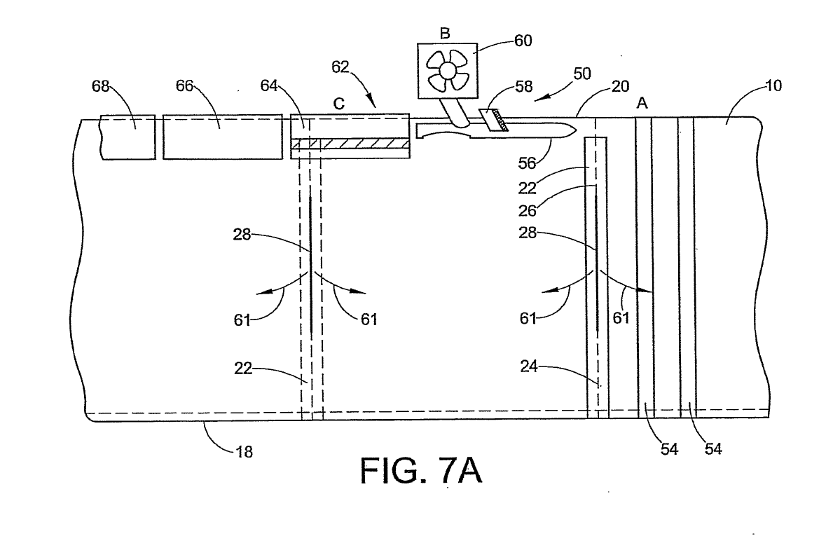

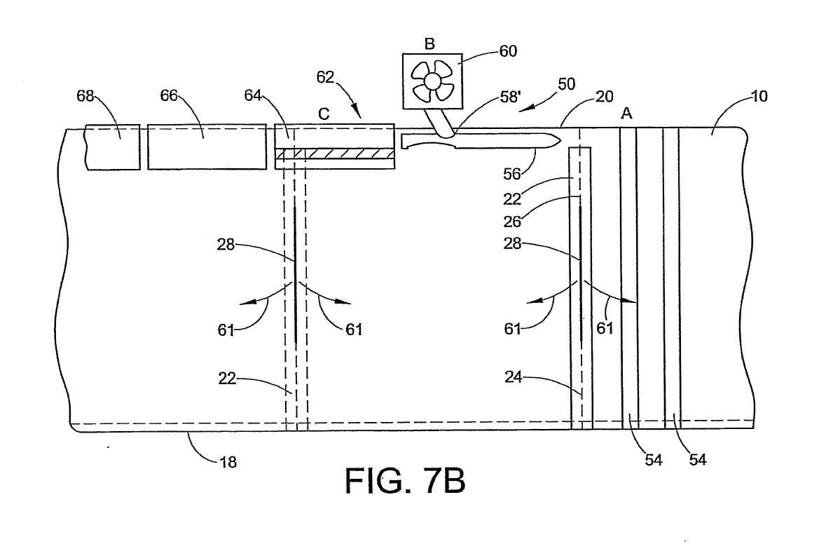

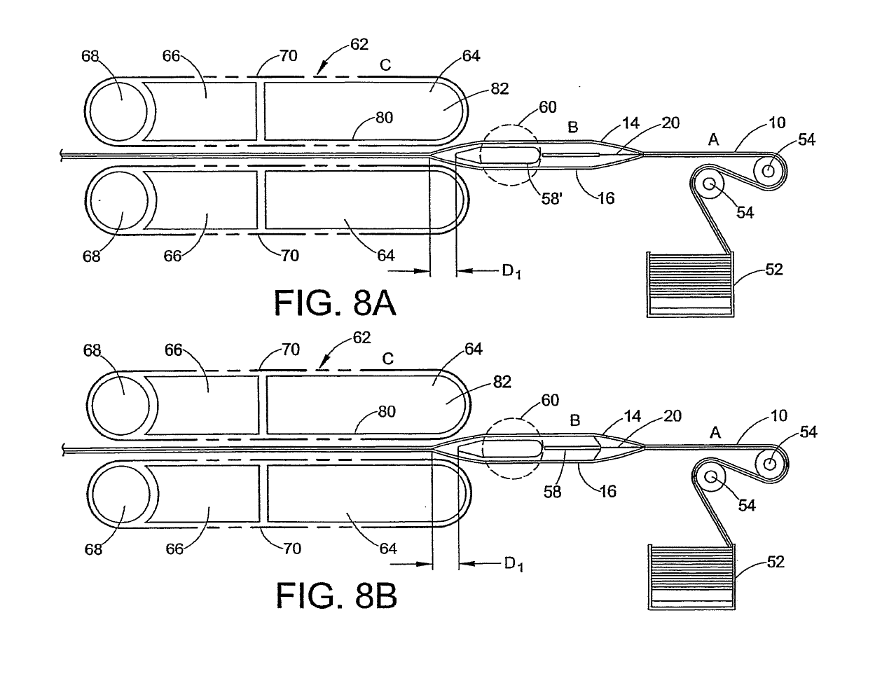

FIGS. 7A, 7B, 8A, 8B and 9 schematically illustrate a machine 50 and process of converting the webs 10, 10′, 10″ and 10′″ to sealed air filled pouches 12′. Referring to FIGS. 7A, 7B, 8A and 8B, a web 10, 10′, 10″ or 10′″ is routed from a supply 52 (FIGS. 8A and 8B) to and around a pair of elongated, transversely extending guide rollers 54. The guide rollers 54 keep the web taught as the web 10 is pulled through the machine 50. At location A, the web pouches are uninflated. In the embodiment illustrated by FIG. 5, pouch edges 38, 40 defined by the cut 31 are close to one another at location A. In the embodiments illustrated by FIGS. 4 and 6, the frangible connections 29, 36 are of sufficient strength to remain intact at location A.

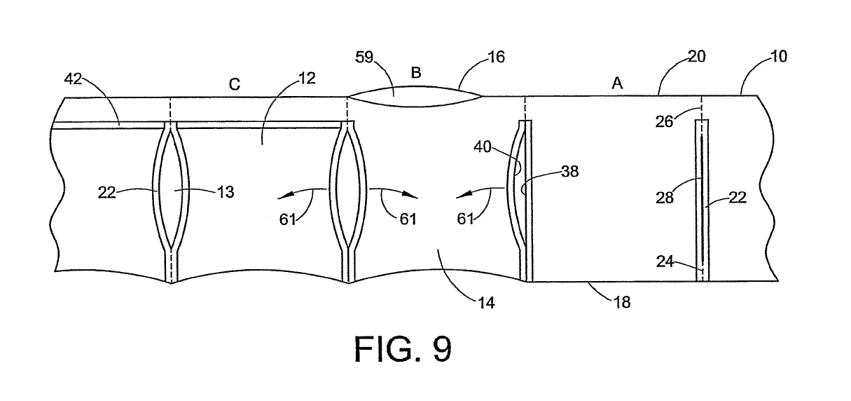

A longitudinally extending guide pin 56 is disposed in the web at station B. The guide pin 56 is disposed in a pocket bounded by the top and bottom layers 14, 16, the inflation edge 18, and ends of the transverse seals 22. The guide pin 56 aligns the web as it is pulled through the machine. A separator, such as a knife cutter 58 (FIGS. 7A and 8A), or a blunt surface 58′ (FIGS. 7B and 8B) is present on the guide pin 56. In the embodiment illustrated by FIGS. 7A and 8A the knife cutter 58 extends from the guide pin 56. The knife cutter 58 is used to cut the inflation edge 18 illustrated by FIG. 1, but could also be used to cut the perforated inflation edge 18 illustrated by FIG. 2. The cutter 58 slits the inflation edge 18 as the web moves through the machine 50 to provide inflation openings 59 (See FIG. 9) into the pouches, while leaving the pouches otherwise imperforate. A variation of this would have the cutter 58 cutting either layer 14, 16, or both near the inflation edge 18. In the embodiment illustrated by FIGS. 7B and 8B, the guide pin 56 defines a separator in the form of the blunt surface 58′ and the knife cutter is omitted. The blunt surface 58′ is used to break the perforated inflation edge illustrated by FIG. 2. The blunt surface 58′ breaks open the inflation edge 18 as the web moves through the machine to provide the inflation openings into the pouches 12.

A blower 60 is positioned after the cutter 58 or blunt surface 58′ in station B. The blower 60 inflates the web pouches as the web moves past the blower. Referring to FIG. 9, the web pouches are opened and inflated at station B. The seal edges 38, 40 spread apart as indicated by arrows 61 (FIGS. 7A, 7B and 9) as the web pouches are inflated. In the embodiment illustrated by FIGS. 4 and 6, the frangible connections 29, 36 maintain successive pouches substantially aligned as the web is fed to the filling station B. The frangible connections are sufficiently weak that the connection between a pouch that has been opened for inflation and is being inflated at the fill station B and an adjacent, successive (or preceding) pouch will rupture as the pouch at the fill station is inflated. The spreading of the edges 38, 40 forms a row of inflated sealed air filled pouches in a ladder configuration and increases the volume of the air that can enter the pouches. The spreading also reduces the stresses imparted to the web adjacent the inflation side edge 18 where it is to be sealed.

The inflation seal 42 is formed at station C by a sealing assembly 62 to complete each dunnage unit. In the exemplary embodiment, the inflated volume of the pouches is maintained by continuing to blow air into the pouch until substantially the entire length of the inflation opening 59 is sealed. In the example of FIGS. 8A, 8B and 9, the blower 60 blows air into a pouch being sealed up to a location that is a short distance D1 from closing position where the sealing assembly 62 pinches the top and bottom layers 14, 16 to maintain the inflated volume of the pouches. This distance D1 is minimized to minimize the volume of air that escapes from the inflated pouch before the trailing transverse seal of the inflated pouch reaches the closing position. For example, the distance D1 may be about 0.250 inches or less, to blow air into the inflation opening unit the trailing transverse seal is within 0.250 inches of the closing position.

In the examples illustrated by FIGS. 8A and 8B, the sealing assembly includes a pair of heated sealing elements 64, a pair of cooling elements 66, a pair of drive rollers 68, and a pair of drive belts 70. In an alternate embodiment, the pair of cooling elements is omitted. Each belt 70 is disposed around its respective heat sealing element 64, cooling element 66 (if included), and drive roller 68. Each belt 70 is driven by its respective drive roller 68. The belts 70 are in close proximity or engage one another, such that the belts 70 pull the web 10 through the heat sealing elements 64 and the cooling elements 66. The seal 42 is formed as the web 10 passes through first the heated sealing elements 64 and then a heat sink such as the cooling elements. One suitable heating element 64 includes heating wire 80 carried by an insulating block 82. Resistance of the heating wire 80 causes the heating wire 80 to heat up when voltage is applied. The cooling elements 66 cool the seal 42 as the web 10 is pulled between the cooling elements. One suitable cooling element is an aluminum (or other heatsink material) block that transfers heat away from the seal 42. Referring to FIG. 9, the spreading of the edges 38, 40 greatly reduces the stress imparted on the web material at or near the seal 42. As a result, a much more reliable seal 42 is formed.

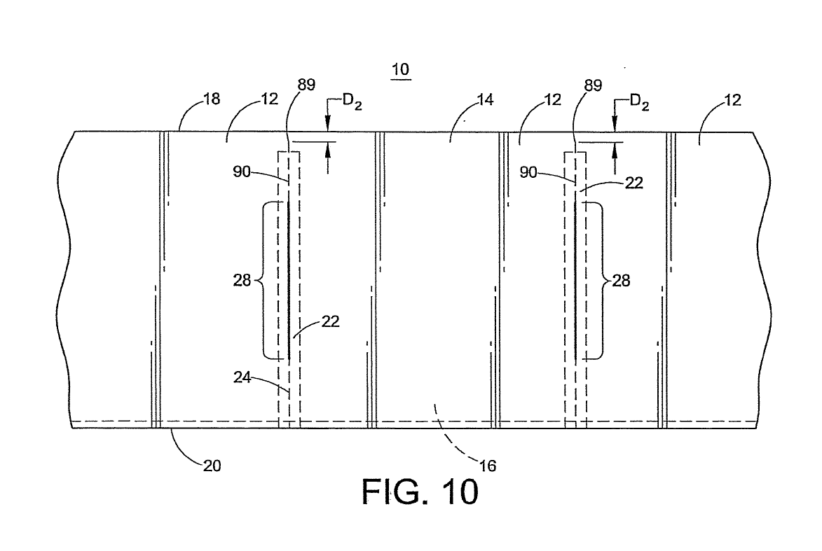

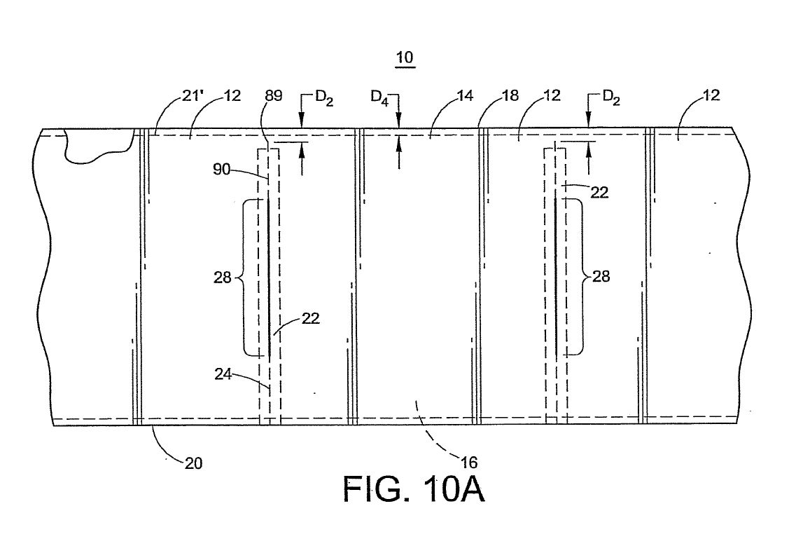

FIGS. 10-12 show another embodiment of a web 10. In this embodiment, the spaced apart lines of perforations 26 extending from the inflation edge, as shown in FIGS. 1-7B and 9, is replaced with a modified line of perforations 90. As best seen in FIG. 10, a starting point 89 of the line of perforations 90 begins a distance D2 from the inflation edge 18 and extends away from and generally perpendicular to the inflation edge 18. As can be seen in FIG. 10A, in an embodiment in which a frangible connection 21′ (also shown in FIG. 2A) is offset from the inflation edge 18 by a distance D4, the distance D2 is greater than the distance D4. Hence, in the examples illustrated by FIGS. 10-12, the line of perforations 90 extends to a gap forming area 28 and an opposite edge line of perforations 24 extends to the opposite edge. In another embodiment, the gap forming area 28 is not included and the line of perforations 90 extends all the way or nearly all the way to the opposite edge.

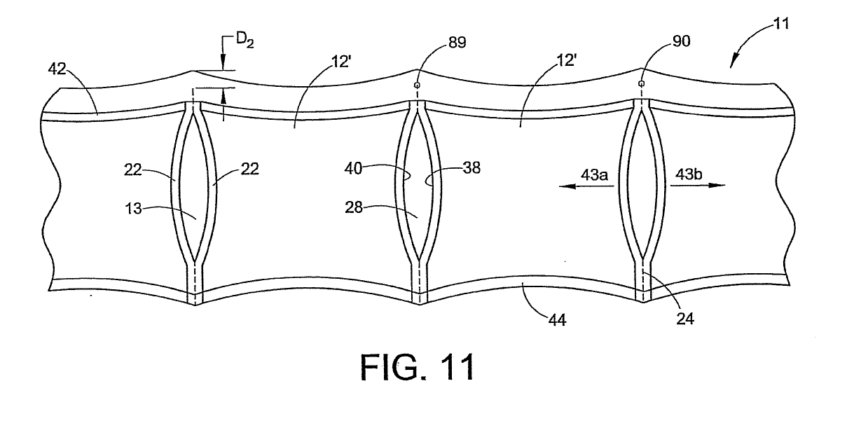

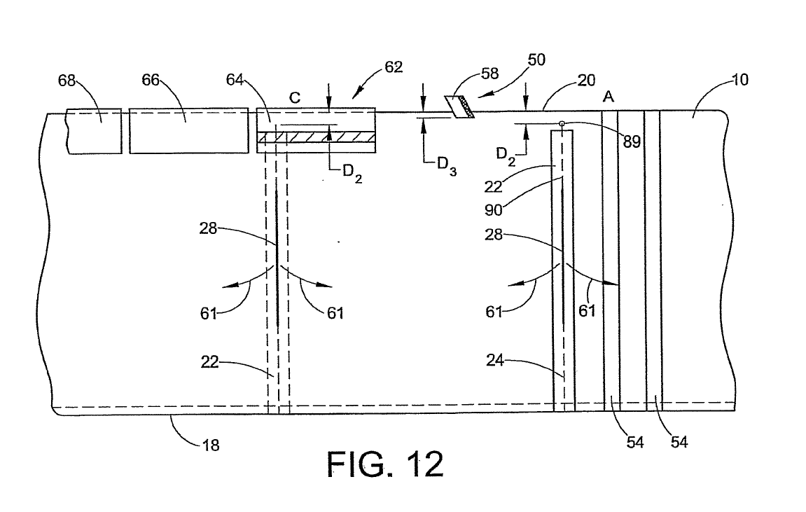

The distance D2 is selected to prevent the cutter (FIG. 12) from engaging the line of perforations in the exemplary embodiment. Although distance D2 may vary based on the particular cutter implemented, in one embodiment, distance D2 is approximately 0.25 inches to approximately 0.375 inches in length. FIG. 11 illustrates a row of inflated sealed air filled pouches. The elimination of perforations extending to the inflation edge 18 does not make it substantially harder to separate adjacent sealed air filled pouches in the row 11 of sealed air filled pouches 12′ in the exemplary embodiment. The sealed air filled pouches 12′ can still be separated by inserting an object or objects, such as a hand or hands, into the gap 13 and pulling one dunnage unit 12′ away from an adjacent dunnage unit 12′. When the sealed air filled pouches are pulled apart, the thin web of material between the starting point 89 and the inflation edge easily breaks.

The process of forming perforations through the top and bottom layers of plastic 14, 16, as the web 10 is formed, may cause the top and bottom layers 14, 16 to adhere or be held together at the line of perforations. When the lines of perforations extend all the way to the inflation edge and the cutter 58 cuts on one side of the inflation edge, the cutter will engage each line of perforations. Engagement of the lines of perforations by the cutter may cause the web to bind, wrinkle, bunch up, or gather around the edge of the cutter until the cutter passes the line of perforations and begins cutting the web again. In the embodiment illustrated by FIGS. 10-12, engagement of the line of perforations 90 with the cutter is eliminated by beginning the line of perforations 90 a distance D2 away from the inflation edge 20. As illustrated in FIG. 12, the tip of a cutter 58 utilized in opening the inflation edge 20 is positioned a distance D3 past the inflation edge 20 as the edge is opened. The distance D2 that the line of perforations 90 is away from the inflation edge 20 is configured to be greater than the distance D3 to which the tip of a cutter 58 is positioned past the inflation edge 20. As a result, the cutter 58 will not engage the lines of perforations. Likewise, in the case of the frangible connection 21′ shown in FIG. 10A, the cutter 58 or blunt surface 58′ (FIG. 7B) that opens the offset frangible connection 21′ will not engage the lines of perforations 90. This eliminates the possibility that the cutter or blunt surface could engage the lines of perforations and cause the web to bunch up or gather around the cutter 58 or blunt surface 58′ as the cutter 58 opens the inflation edge.

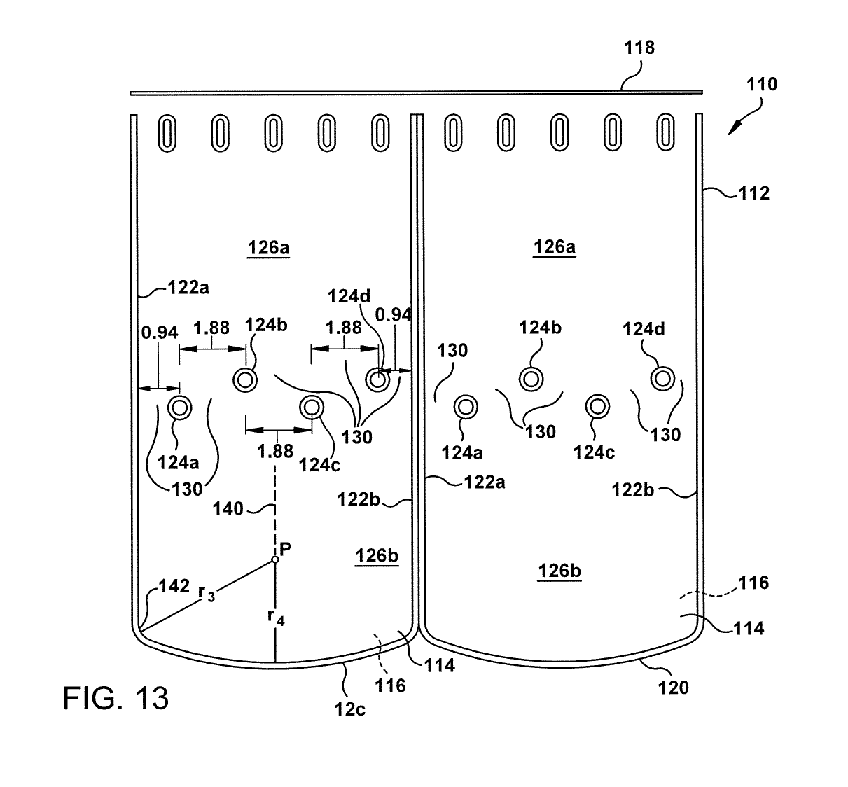

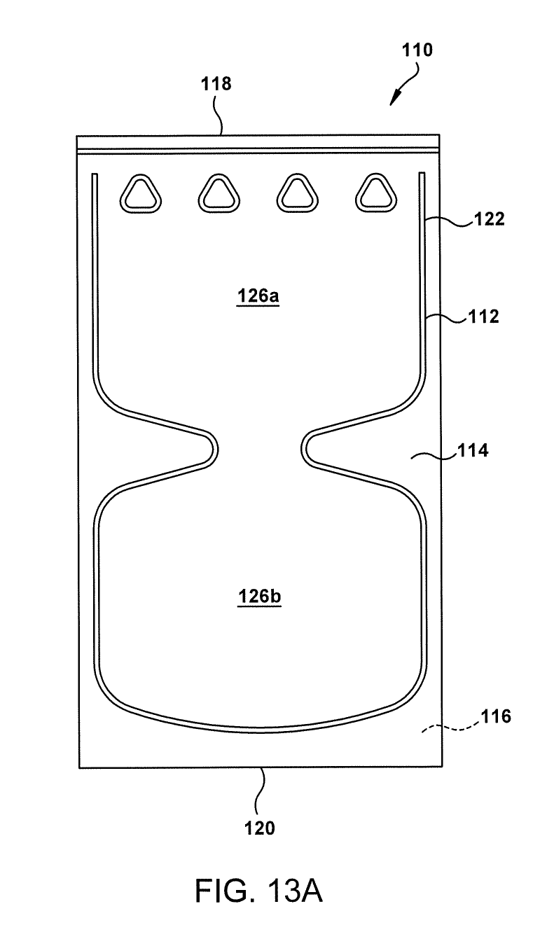

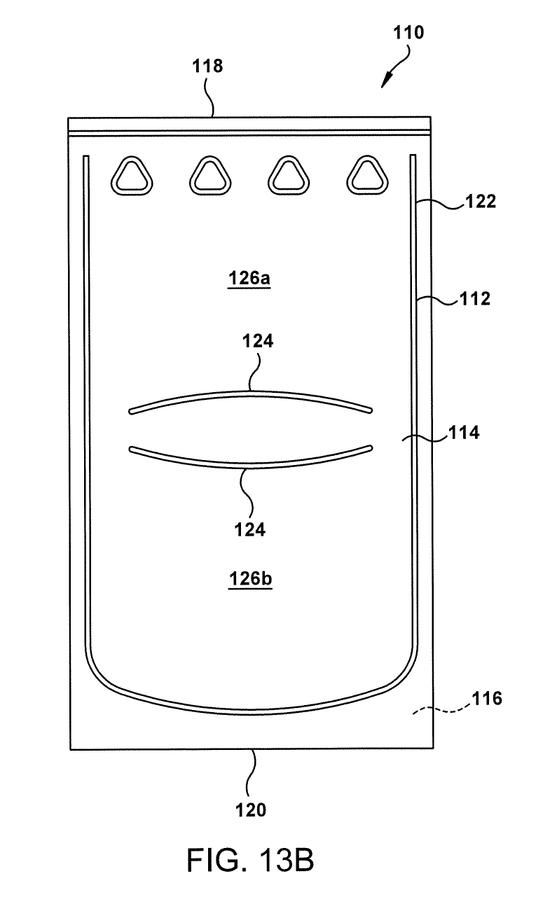

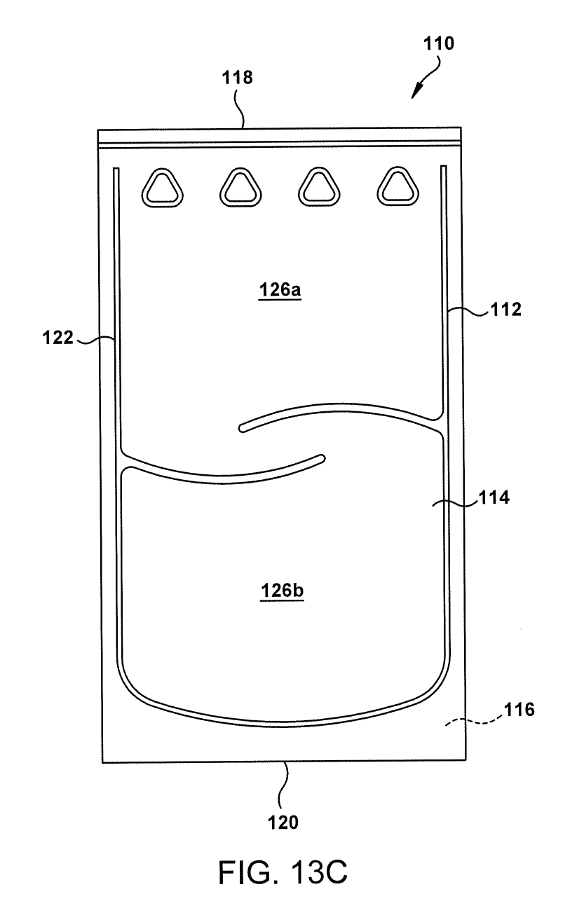

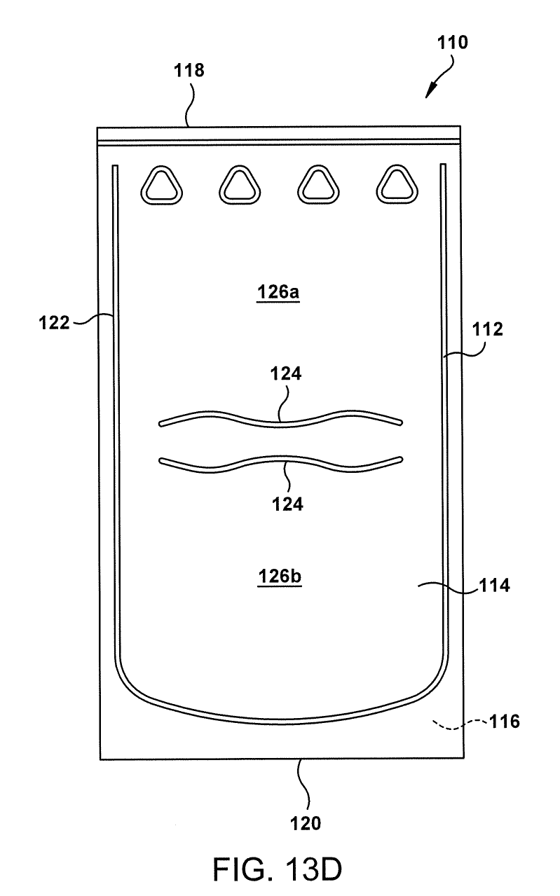

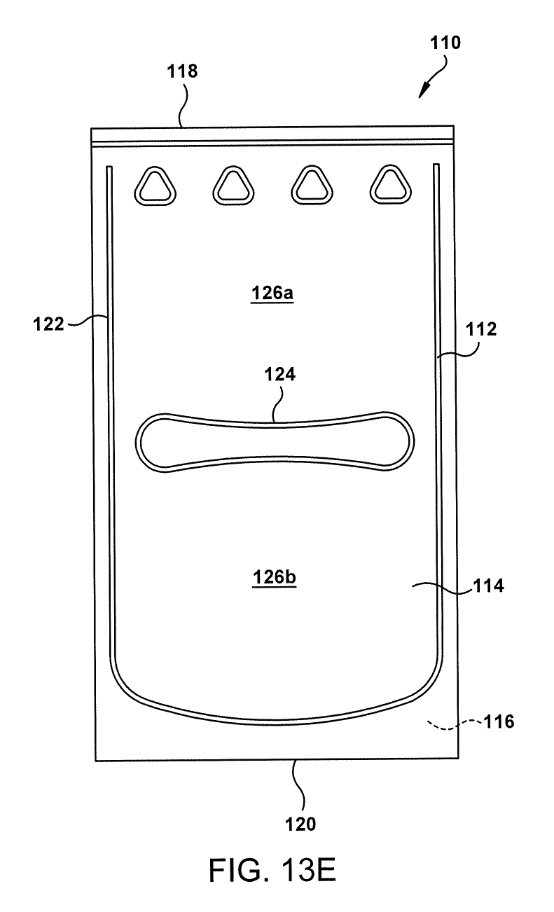

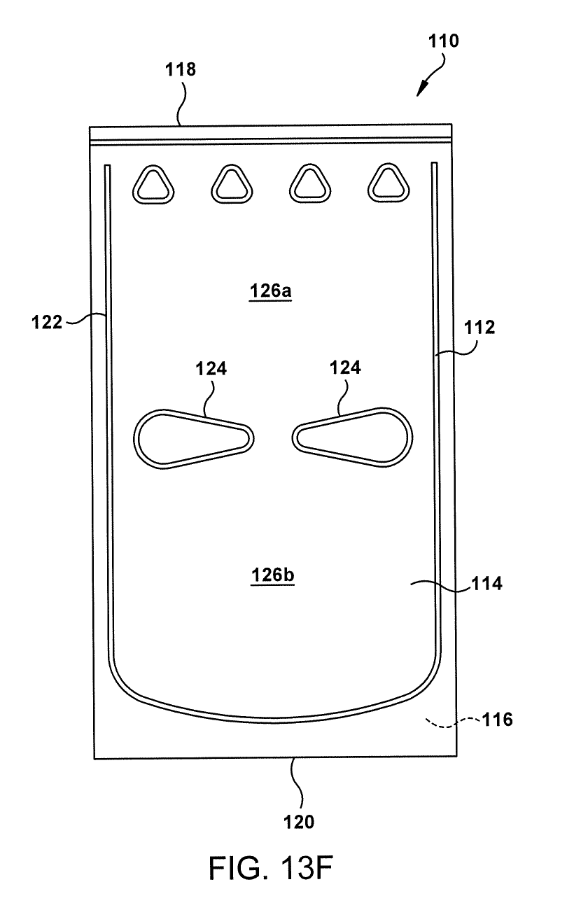

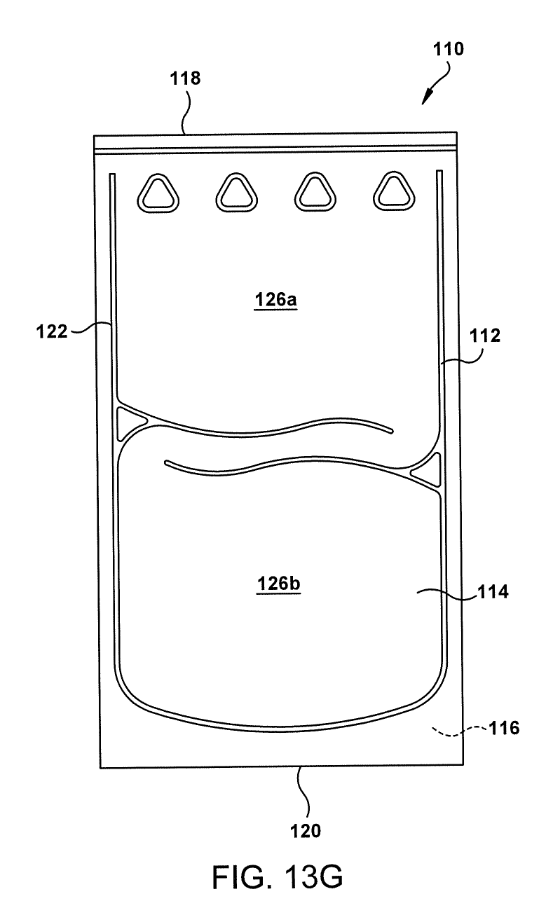

With reference to FIGS. 13 and 13A-13G, other embodiments of the present invention are illustrated in which webs 110 of inflatable sealed air filled pouches 112 are shown. As in the previous embodiments, the webs 110 include a top elongated layer of plastic 114 superposed onto a bottom layer of plastic 116. The layers 114, 116 are connected together along spaced edges, referred to as the inflation edge 118 and the opposite edge 120. Transverse seals 122 join the top and bottom layers 114, 116.

In the examples illustrated by FIGS. 13, 13B, 13D, 13E, 13F, one or more internal seals 124 define two (2) chambers 126a, 126b within each pouch 112. Each of the internal seals 124 seals the layers 114, 116 together. In the exemplary embodiment illustrated by FIG. 13, embodiment, four (4) of the internal seals 124a, 124b, 124c, 124d (collectively 124) are circular and faun a staggered pattern, which is described in more detail below. However, other embodiments, including different numbers of the internal seals 124 of other shapes and/or other patterns of the internal seals 124 are also contemplated (See FIGS. 13B, 13D, 13E, and 13F).

Regardless of the pattern defined by the internal seals 124, it is to be understood that unsealed portions 130 are defined around and between the internal seals 124a, 124b, 124c, 124d. Furthermore, unsealed portions 130 also exist between the transverse seal 122a and the internal seal 124a and between the transverse seal 122b and the internal seal 124d.

In the examples illustrated by FIGS. 13A, 13C, and 13G, one or more internal side connected seals 125 define two (2) chambers 126a, 126b within each pouch 112. Each of the side connected seals 125 seals the layers 114, 116 together and are connected to a seal 122. Different numbers of the side connected seals 125 of other shapes and/or other patterns of the internal seals 124 are also contemplated.

The dimensions of the webs 110 disclosed by the present application can be selected to accommodate any packaging application. In one non-limiting example, web shown in FIG. 13 can have the dimensions as shown and described as follows. The inflation edge 118 may be about 16.00 inches from a bottom of the opposite edge 120. Furthermore, the transverse seal 122a may be about 7.53 inches from the transverse seal 122b. It is contemplated that respective centers of the internal seals 124b, 124d are about 7.80 inches from the inflation edge 118 along respective axes parallel to the transverse seals 122a, 122b, and that respective centers of the internal seals 124a, 124c are about 7.80 inches from the opposite edge 120 along respective axes parallel to the transverse seals 122a, 122b. In addition, a center of the internal seal 124a is about 0.94 inches from the transverse seal 122a and about 1.88 inches from a center of the internal seal 124b along a first axis perpendicular to the transverse seals 122a, 122b, the center of the internal seal 124b is about 1.88 inches from a center of the internal seal 124c along a second axis perpendicular to the transverse seals 122a, 122b, the center of the internal seal 124c is about 1.88 inches from a center of the internal seal 124d along the first axis perpendicular to the transverse seals 122a, 122b, and a center of the internal seal 124d is about 0.94 inches from the transverse seal 122b along the second axis perpendicular to the transverse seals 122a, 122b.

The unsealed portions 130 around the internal seals 124 provide for fluid communication between the chambers 126a, 126b, even after the pouches 112 are filled with fluid and sealed as discussed above.

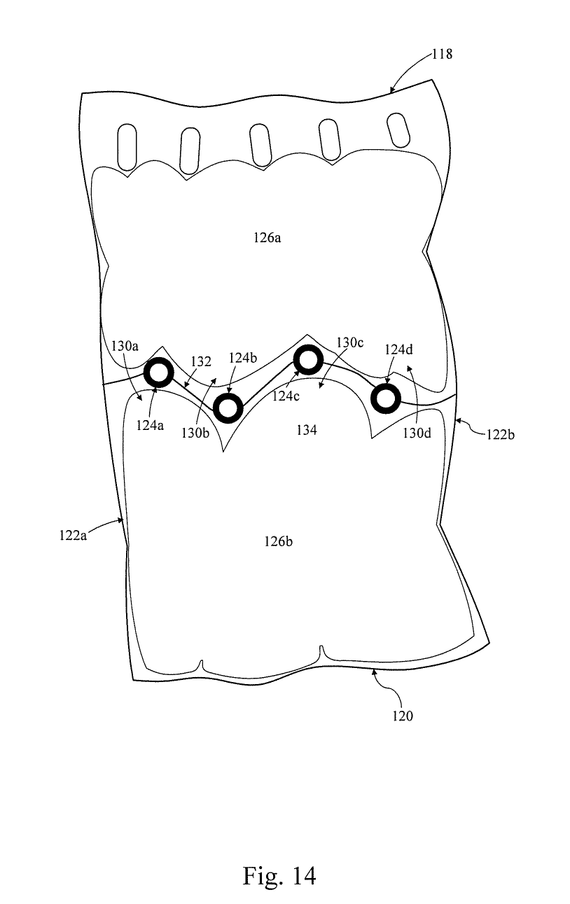

As illustrated in FIG. 14, the staggered pattern of the internal seals 124a, 124b, 124c, 124d create respective extensions 130a, 130b, 130c, 130d (e.g., “fingers”) that protrude into the chambers 126a, 126b. For example, the internal seal 124a creates the extension 130a that protrudes into the chamber 126a, the internal seal 124b creates the extension 130b that protrudes into the chamber 126b, the internal seal 124c creates the extension 130c that protrudes into the chamber 126a, and the internal seal 124d creates the extension 130d that protrudes into the chamber 126b. When the pouch 112 is folded along a fold area 132 created by the pattern of internal seals 124 between the chambers 126a, 126b, the extensions 130 overlap one another to create a cushioned area 134 along the fold area 132. More specifically, the extension 130a overlaps the extension 130b, the extension 130b overlaps the extensions 130a and 130c, the extension 130c overlaps the extensions 130b and 130d, and the extension 130d overlaps the extension 130c.

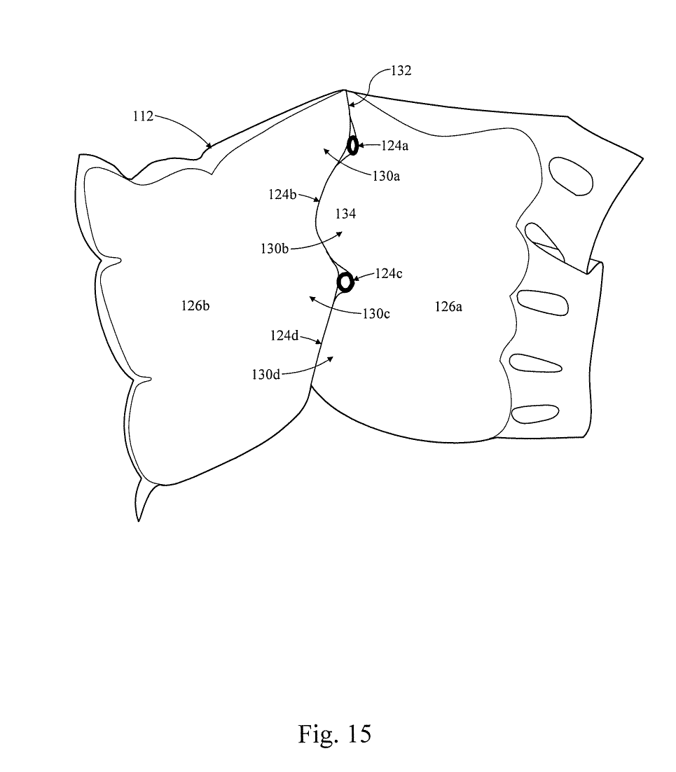

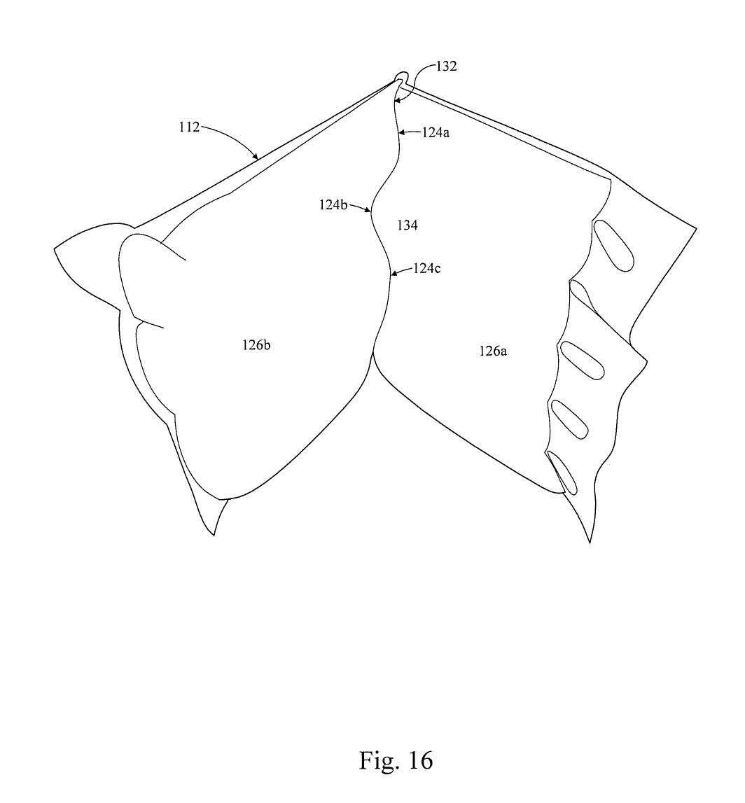

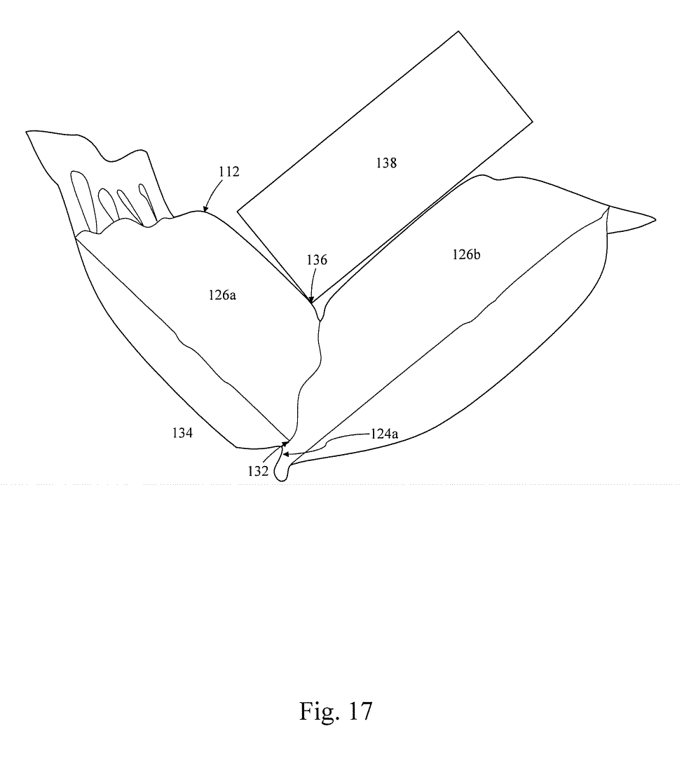

FIG. 15 illustrates the pouch 112 of FIG. 13 partially folded along the fold area 132. FIG. 16 illustrates the pouch 112 more completely folded, relative to FIG. 15, along the fold area 132. FIG. 17 illustrates the pouch 112 more completely folded, relative to FIG. 16, along the fold area 132. With reference to FIGS. 15-17, the overlapping extensions 130a, 130b, 130c, 130d cooperate to create the cushioned area 134.

As illustrated in FIG. 17, the pouch 112 may be folded around a corner 136 of a container 138 (e.g., a box). The cushioned area 134 created by the overlapping extensions 130a, 130b, 130c, 130d acts to protect the edge 136 of the container 138 from potential damage caused by an external impact. More specifically, the overlapping extensions 130a, 130b, 130c, 130d act to prevent the edge 136 of the container 138 from reaching the fold area 132. Consequently, the edge 136 is cushioned by the extensions 130a, 130b, 130c, 130d.

Although the internal seals have been describes with reference to the pouch 112 illustrated in FIG. 13, it is to be understood that the internal seals described herein may be used with a pouch of any design, including any of the pouch designs disclosed in FIGS. 1-12 and 13A-13G above.

With reference again to FIG. 13, the opposite edges 120 of the pouches 112 are curved, rather than straight like the opposite edges 20 illustrated in FIG. 1. As discussed above, the term foreshortening refers to the tendency of the length of a pouch side to shorten as the pouch is inflated. The pouch side may become curved as it is shortened. In FIG. 1, a radius r₁ from a point P along a central axis 140 to a corner 144 (e.g., an intersection between the opposite edge 20 and the transverse edge 22) is longer than a radius r₂ from the point P to an inside center of the opposite edge 20. The “inside center” refers to a point inside the pouch 12.

As illustrated in FIG. 13, to achieve the relatively straighter transverse seals 122a, 122b when the pouch 112 is inflated, in one embodiment it is contemplated that the opposite edges 120 of the pouches 112 are curved to reduce the amount of curve in the transverse seals 122a, 122b when the pouches are inflated. For example, the opposite edges 120 are curved away from the inflation edge 118. In FIG. 13, similar to FIG. 1, a radius r₃ from a point P along the central axis 140 to a corner 142 is longer than a radius r₄ from the point P to an inside center of the curved opposite edge 120. The “inside center” refers to a point inside the pouch 12. However, with reference to FIGS. 1 and 13, |r₂−r₁|>|r₃−r₄| to achieve the relatively straighter transverse seals 122a, 122b illustrated in FIG. 13. In one embodiment, |r₃−r₄| is less than a predetermined threshold.

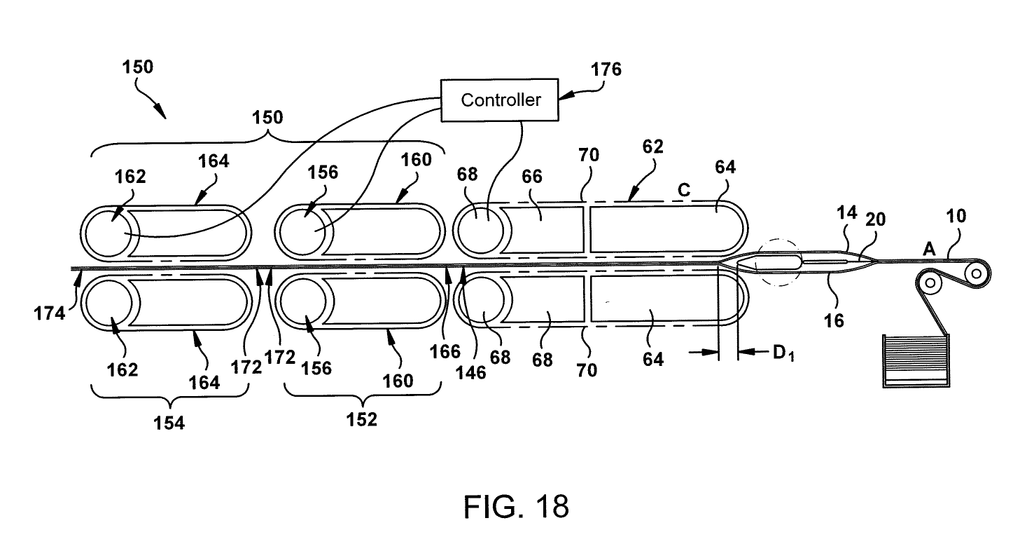

With reference to FIG. 18, a device 150 is illustrated for separating the web 10 into individual pouches 12 or sets of the pouches 12. As discussed with reference to FIG. 1, the web 10 includes spaced pairs of lines of perforations 24, 26 extending through the top and bottom layers 14, 16, and a gap forming area 28 extending between each associated pair of lines of perforations 24, 26. The gap forming area 28 opens to form a gap 13 when the pouches are inflated (see FIG. 3). With reference to FIGS. 1 and 18, the sealing assembly 62 includes the pair of heated sealing elements 64, a pair of cooling elements 66, a pair of drive rollers 68, and a pair of drive belts 70. After passing through the sealing assembly 62, the top and bottom layers 14, 16 of the pouches 12 exit at a point 146. At this point, the web 10 includes the lines of perforations 24, 26 and the gap fouling area 28 between the pouches 12.

After exiting the sealing assembly 62, the web 10 enters a separation assembly 150. In one embodiment, the separation assembly 150 includes a first stage 152 and a second stage 154. The first stage 152 includes rollers 156 and belts 160; and the second stage 154 includes rollers 162 and belts 164. The rollers 156, 162 rotate to move the belts 160, 164 in the first and second stages, respectively.

After the web 10 exits the sealing assembly 62, the web 10 enters the first stage 152 of the separation assembly 150 at a point 166. The rollers 156 and the belts 160 move the web 10 through the first stage 152 of the separation assembly 150 until the web 10 exits the first stage at a point 170. The web 10 then enters the second stage 154 of the separation assembly 150 at a point 172. The rollers 162 and the belts 164 move the web 10 through the second stage 154 of the separation assembly 150 until the web 10 exits the second stage at a point 174.

During use, a controller 176 is used to maintain the rollers 68, belts 70 at substantially the same speed as the roller 156 and belt 160 of the first stage 152 and also at substantially the same speed as the roller 162 and belt 164 of the second stage 154. With the first and second stages 152, 154 operating at the same speed as the rollers 68 and belts 70 of the sealing assembly 62, the web 10 is not separated along the lines of perforations 24, 26 to separate a pouch 12 or a set of the pouches 12 from the web 10.

When it is desired to separate an individual pouch 12 or a set of the pouches 12 from the web 10, the controller 176 varies the speed of at least one of the first and second stages 152, 154 of the separation assembly 150. For example, the controller 176 may cause the roller 156 of the first stage 152 to rotate relatively slower than the roller 162 of the second stage 154 by a predetermined threshold. More specifically, the roller 156 of the first stage 152 may simply rotate slower than the roller 162 of the second stage 154 by the predetermined threshold, or the roller 156 of the first stage 152 may even stop. Therefore, the belt 160 moves relatively slower than the belt 164. With the web 10 in both the first and second stages 152, 154, the relatively slower moving belt 160 causes a stress at the lines of perforations 24, 26 between the first and second stages 152, 154, which results in the web 10 separating (e.g., tearing) at the lines of perforations 24, 26. Once the web 10 is separated, the controller 176 causes the first and second stages 152, 154 to return to a speed substantially the same as the rollers 68 and belts 70.

It is to be understood the controller 176 may be operated or programmed to selectively control the speeds of the roller 156 and belt 160 of the first stage 152 and the roller 162 and belt 164 of the second stage 154 to separate the web 10 into individual pouches 12 or sets of pouches 12.

Although the separation assembly 150 is illustrated as including the first and second stages 152, 154, it is to be understood that the separation assembly 150 may only include a single stage or, alternatively, may include three or more stages.

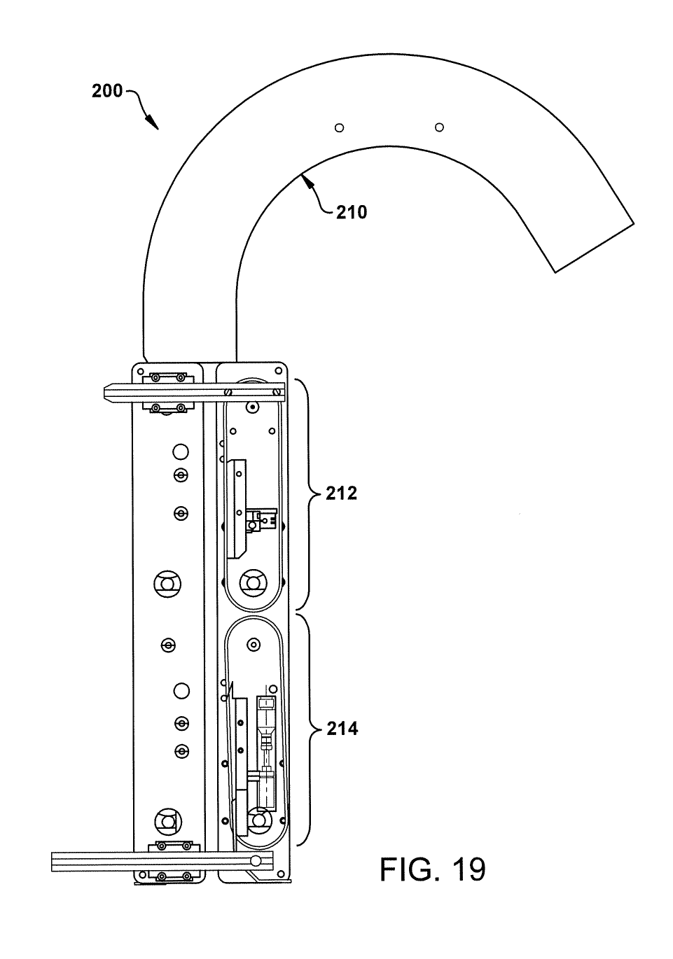

FIG. 19 illustrates a side view of another representation of a separation assembly 200 for separating the web 10 into individual pouches 12 or sets of the pouches 12.

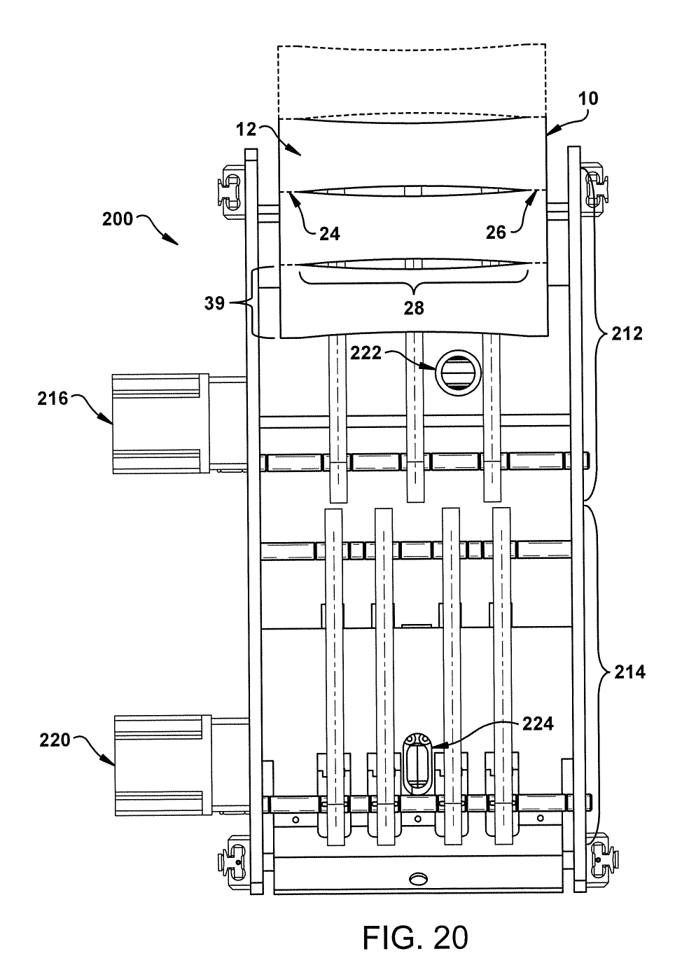

FIG. 20 illustrates a front view of the a separation assembly 200. The web (e.g., a pillow chain) is fed into an infeed 210 (shown in FIG. 19) of the separation assembly 200. With reference to FIGS. 1, 19, and 20, while the first belt section 212 (e.g., corresponding to the first stage 152 in FIG. 18) and the second belt section 214 (e.g., corresponding to the second stage 154 in FIG. 18) travel at a relatively constant speed, the pillow chain advances through the separation assembly 200 at a relatively constant speed. When it is desired to separate a pouch 12 or a set of pouches 12 from the web 10, the first belt assembly 212 is operated at a slower speed, or even stopped, relative to the second belt assembly 214. A controller, as discussed above, may be used for controlling the speeds of the first and second belt assemblies 212, 214. The slower relative speed of the first belt assembly 212 causes a stress at the lines of perforations 24, 26 between the first and second belt assemblies 212, 214, which results in the web 10 separating (e.g., tearing) at the lines of perforations 24, 26. Once the web 10 is separated, the controller may cause the first and second belt assemblies 212, 214 to return to a speed substantially the same.

As illustrated in FIG. 20, the first and second belt assemblies 212, 214 are driven by first and second drives 216, 220, respectively. The controller discussed above can control the speeds of the first and second belt assemblies 212, 214 via the first and second drives 216, 220, respectively. The controller receives input from a first sensor 222 positioned behind the first belt assembly 212 and a second sensor 224 positioned behind the second belt assembly 214. The first sensor 222 is an optical sensor capable of detecting the edges of the gap forming area 28 of each pouch 12 and sending a signal to the controller when an edge is detected. The controller increments a counter for the first edge of each pouch 12 that passes within the field of view of the first sensor 222, thereby counting the number of pouches 12 that pass by the first sensor 222. The controller is also capable of calculating the width 39 of each pouch 12 using the timing of the signals from the first sensor 222 and the speed of the first belt assembly 212. The second sensor 224 is a motion sensor that detects motion in the web 10 of pouches 12 when a chain of pouches is manually separated from the web 10 by the operator when the separation assembly 200 is in manual tear mode.

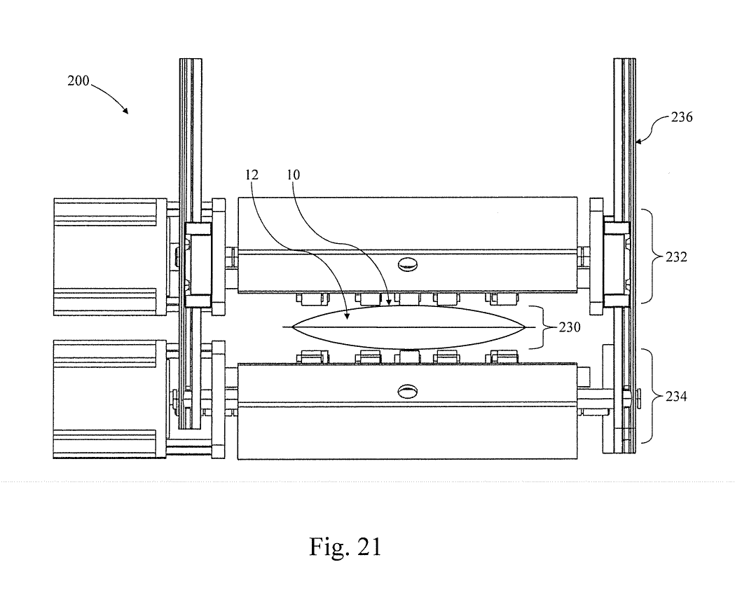

FIG. 21 illustrates a bottom view of the separation assembly 200 shown in FIGS. 19 and 20. A web 10 of pouches 12 is shown passing through the separation assembly 200. To accommodate the different thickness of different types of pouches 12, the adjustable belt assembly 232 can be moved on supports 236 to adjust the gap 230 between the adjustable belt assembly 232 and the fixed belt assembly 234. The gap 230 is adjusted such that the belts in the adjustable and fixed belt assemblies 232, 234 make enough contact with each pouch 12 in the web 10 to move the web 10 through the separation assembly 200 without damage. Each of the adjustable and fixed belt assemblies 232, 234 are comprised of half of the first and second belt assemblies 212, 214, and one each of the first and second drives 216, 220 shown in FIGS. 19 and 20.

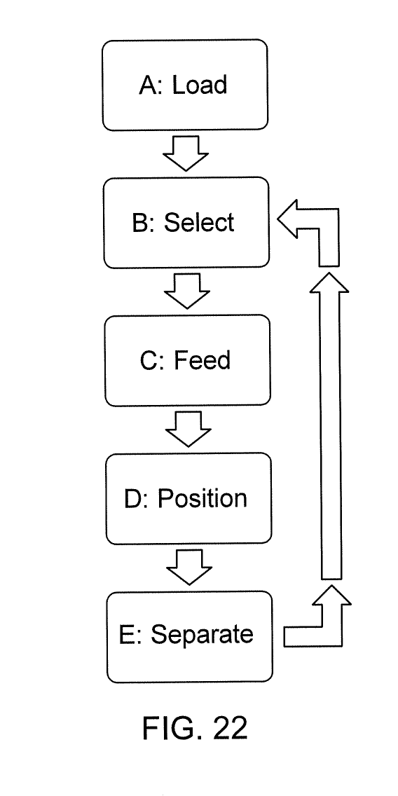

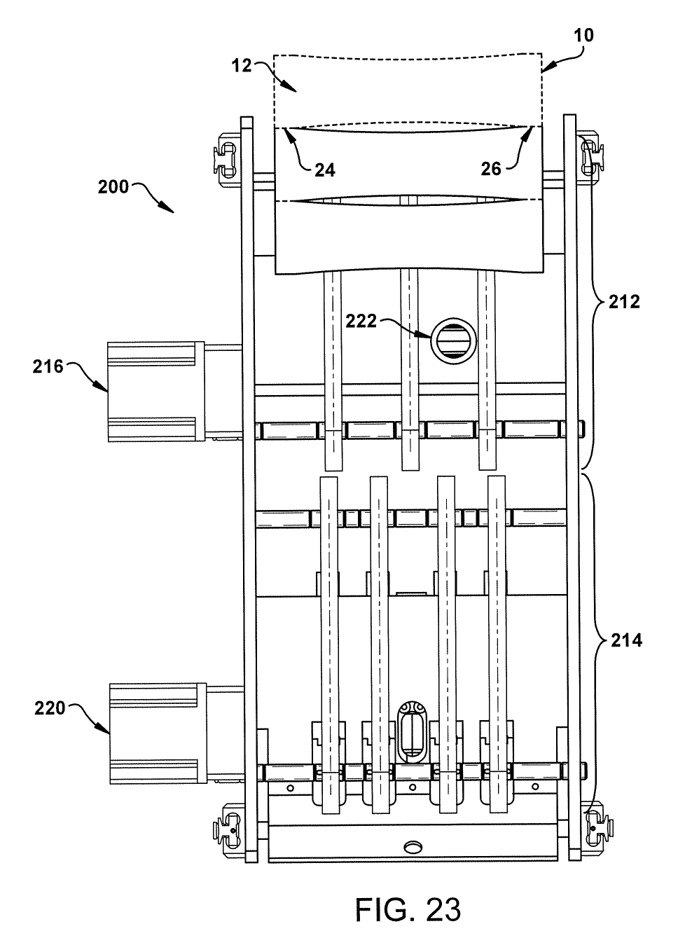

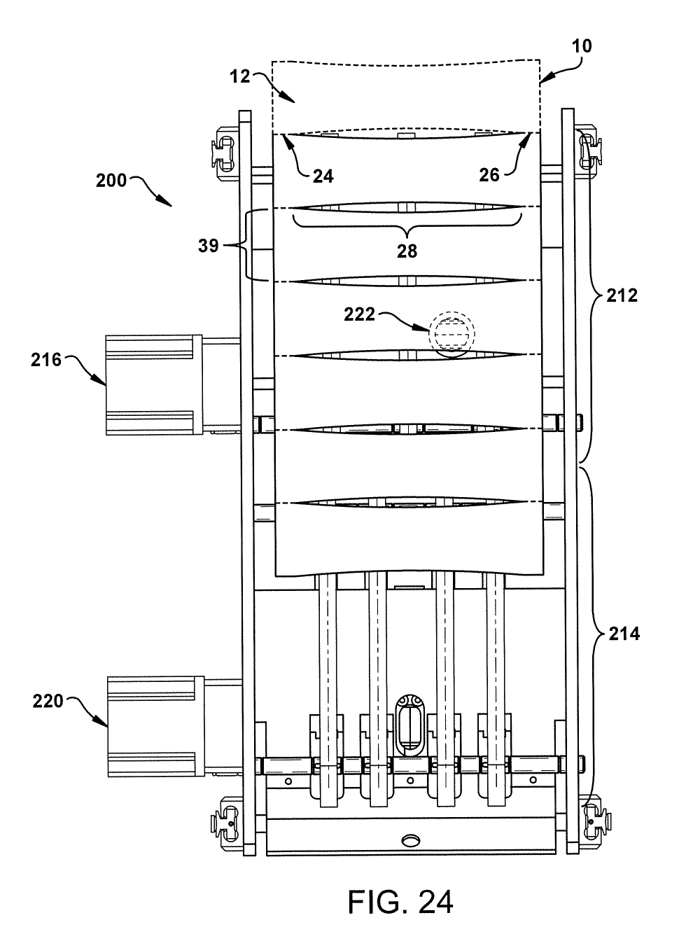

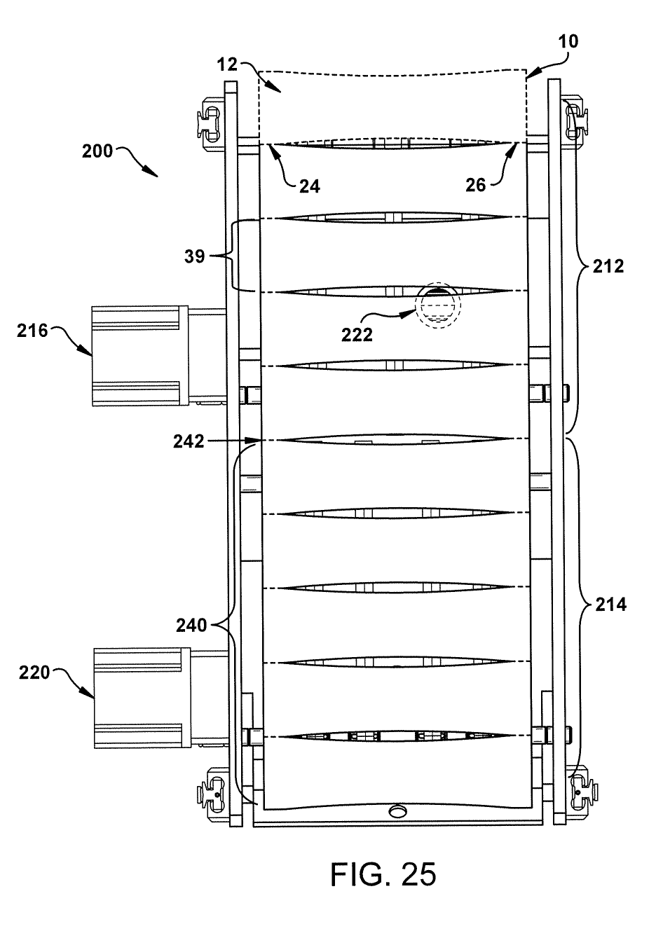

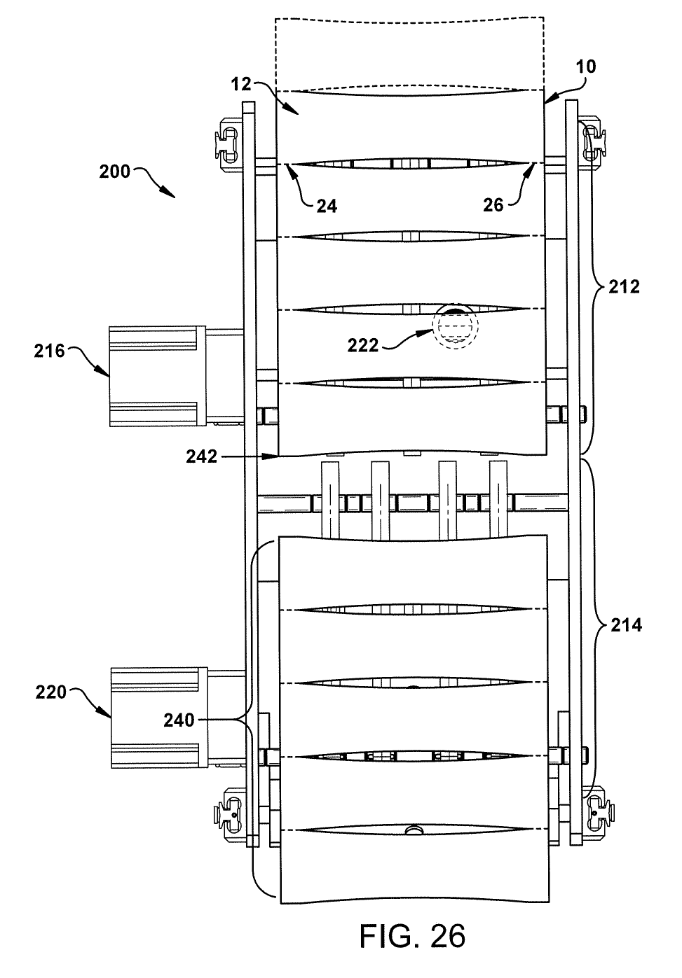

The separation assembly 200 can be set by the operator to operate in one of two different modes: dispenser and manual tear. When dispenser mode is selected the controller follows the flow chart diagram in FIG. 22. The steps of the dispenser mode are illustrated in FIGS. 23-26. Steps A and B are illustrated by FIG. 23. In Step A, the operator loads the web 10 of pouches 12 through the infeed 210 (shown in FIG. 19) into the first belt assembly 212. In Step B, the operator selects the desired number of pouches 12 to be dispensed as a connected chain. Step C is illustrated by FIG. 24. In Step C, the separation assembly 200 feeds the web 10 through the first belt assembly 212 and into the second belt assembly 214. As the web 10 is fed through the first belt assembly 212 the first sensor 222 counts the pouches 12 in the web 10 and the controller uses this information to measure the width 39 of the pouches 12. Step D is illustrated by FIG. 25. After it has counted out the desired number of pouches 12, in Step D the controller stops the first and second belt assemblies 212, 214 so that the last pouch 12 of the desired chain 240 is positioned inside of the second belt assembly 214, and the separation location 242 is between the first and second belt assemblies 212, 214. The controller accurately positions the web 10 in Step D using the width 39 information calculated in Step C, combined with a known stopping time for the first and second belt assemblies 212, 214. Step E is illustrated by FIG. 26. Next, in Step E, the controller directs the second belt assembly 214 to advance while the first belt assembly 212 remains stopped, thereby separating the desired chain 240 from the web 10 at the separation location 242 and dispensing it from the separation assembly 200. After the desired chain 240 has been dispensed, the controller returns to Step B to await the next selection instruction from the operator.

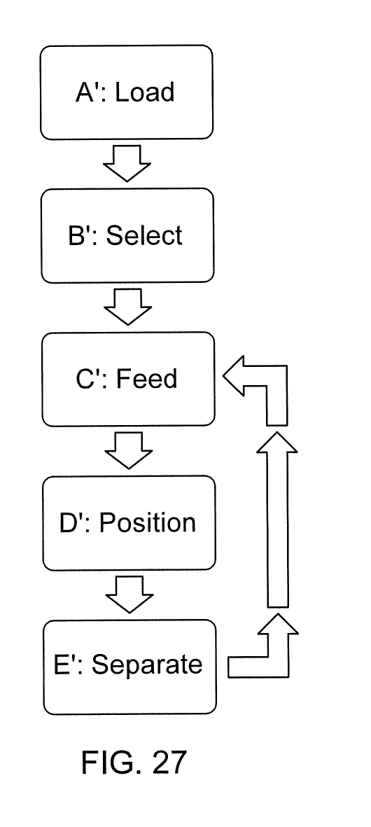

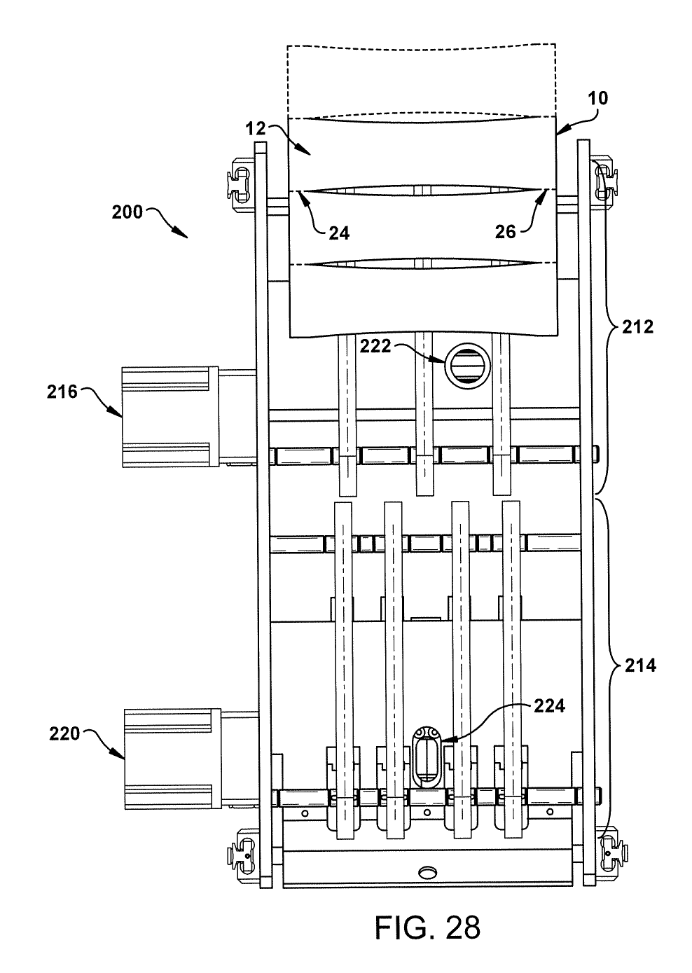

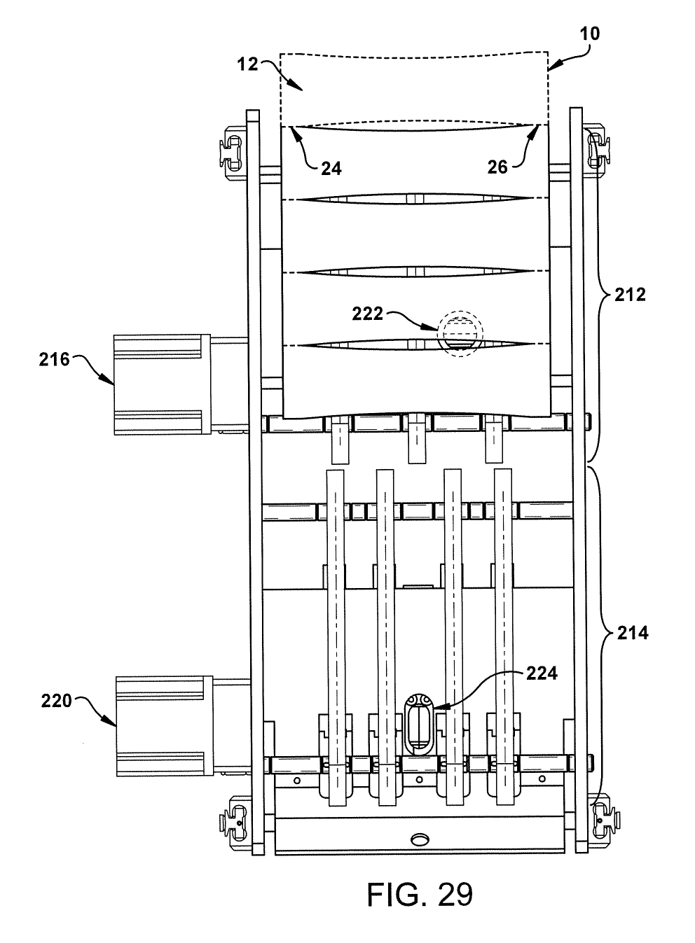

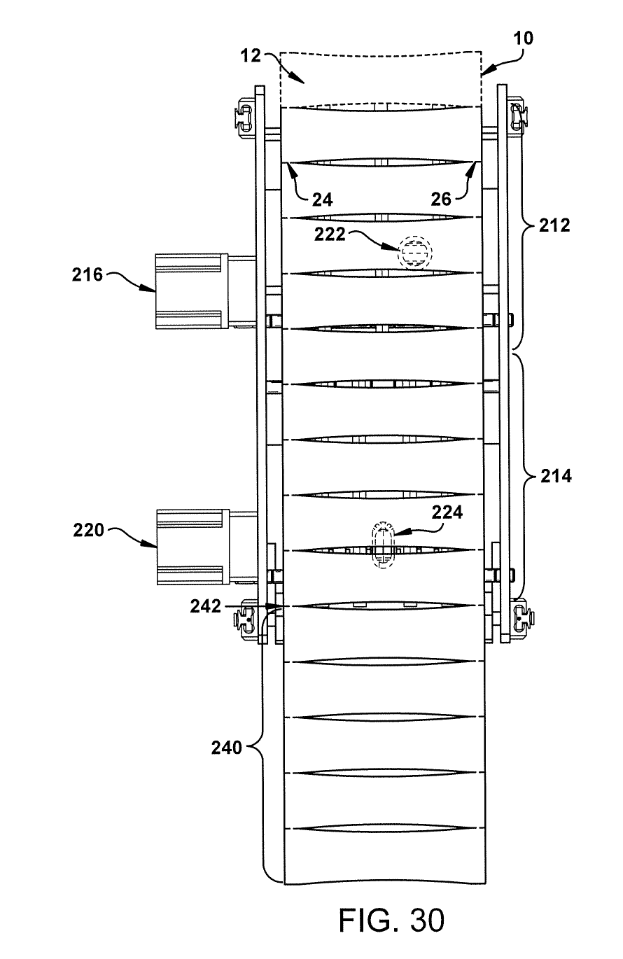

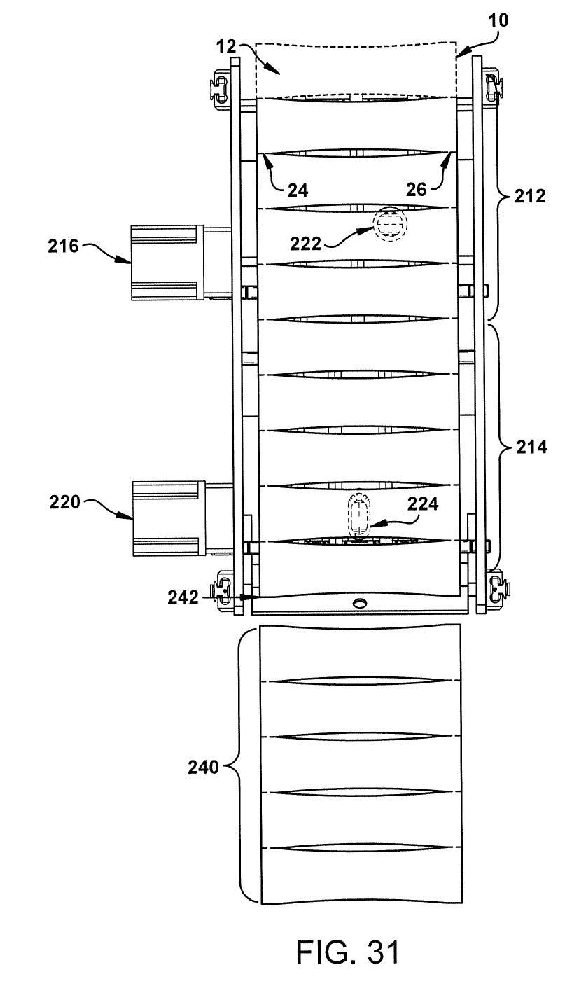

When dispenser mode is selected the controller follows the flow chart diagram shown in FIG. 27. The steps of the manual tear mode are illustrated in FIGS. 28-31. Steps A′ and B′ are illustrated by FIG. 28. In Step A′, the operator loads the web 10 of pouches 12 through the infeed 210 (shown in FIG. 19) into the first belt assembly 212. In Step B′, the operator selects the desired number of pouches 12 to be manually torn off as a connected chain. Step C′ is illustrated by FIG. 29. In Step C′, the separation assembly 200 feeds the web 10 through the first belt assembly 212 and into the second belt assembly 214. As the web 10 is fed through the first belt assembly 212 the first sensor 222 counts the pouches 12 in the web 10 and the controller uses this information to measure the width 39 of the pouches 12. Step D′ is illustrated by FIG. 30. After it has counted out the desired number of pouches 12, in Step D′ the controller stops the first and second belt assemblies 212, 214 so that the last pouch 12 of the desired chain 240 and the separation location 242 are positioned below the second belt assembly 214 and outside of the separation assembly 200. The controller accurately positions the web 10 in Step D′ using the width 39 information calculated in Step C′, combined with a known stopping time for the first and second belt assemblies 212, 214. Step E′ is illustrated by FIG. 31. Next, in Step E′, the operator manually separates the desired chain 240 from the web 10 at the separation location 242 using his hand or some other tool. When the operator removes the desired chain 240, the second sensor 224 detects motion in the web 10 that is within the second belt assembly 214 and sends a signal to the controller. Upon receiving this signal from the second sensor 224, the controller returns to Step C′ and feeds the web 10 forward until another desired chain 240 of pouches in position below the separation assembly 200, ready to be removed by the operator.

Several exemplary embodiments are disclosed by this application. Inflatable webs, machines for sealing inflatable webs, and machines for separating filled and sealed inflated pouches may include any combination or subcombination of the features disclosed by the present application.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

1. A web for forming sealed air filled pouches, comprising:
a first elongated layer;
a second elongated layer superposed over the first elongated layer, the first and second layers connected together at an inflation edge and an opposite edge;
a plurality of transverse seals extending from the opposite edge to a seal termination point that is a distance from the inflation edge, wherein said inflation edge, said opposite edge, and said transverse seals form a plurality of inflatable pouches; and
a plurality of fold seals sealing the first and second elongated layers together along a fold area defining first and second chambers, the fold seals creating a cushioned area along the fold area when the first chamber is folded over the second chamber.

2. The web for forming sealed air filled pouches as set forth in claim 1, further including:
a plurality of unsealed portions, around the respective fold seals, providing fluid communication between the first and second chambers.

3. The web for forming sealed air filled pouches as set forth in claim 1, wherein:
the fold seals are arranged in a staggered pattern.

4. The web for forming sealed air filled pouches as set forth in claim 3, wherein:
the staggered pattern of the fold seals creates extensions protruding into the respective chambers.

5. The web for forming sealed air filled pouches as set forth in claim 4, wherein:
the extensions overlap when the first chamber is folded over the second chamber to create the cushioned area.

6. A web for forming sealed air filled pouches, comprising:
a first elongated layer;
a second elongated layer superposed over the first elongated layer, the first and second layers connected together at an inflation edge and an opposite edge; and
a plurality of transverse seals extending from the opposite edge to a seal termination point that is a distance from the inflation edge, wherein said inflation edge, said opposite edge, and said transverse seals form a plurality of inflatable pouches;
wherein the opposite edge is curved away from the inflation edge.

7. The web for forming sealed air filled pouches as set forth in claim 6, wherein:
an absolute value of a difference between a radius from a point along a central axis to an inside center of the curved opposite edge and a radius from the point to an intersection of the curved opposite edge and a transverse edge is less than a predetermined threshold.

8. The web for forming sealed air filled pouches as set forth in claim 6, wherein:
the transverse seals are substantially parallel when the inflatable pouches are inflated.

9. A device for separating pouches defined by lines of perforations in a web, the device comprising:
a first stage including a first belt operating at a first speed;
a second stage including a second belt operating at a second speed, the web passing through the first stage before passing through the second stage, a pouch being separated from the web at the lines of perforations when a relative speed of the first belt is slower than a speed of the second belt.

10. The device for separating pouches defined by lines of perforations in a web as set forth in claim 9, wherein:
the first belt is stopped while the second belt continues to move for separating the pouch from the web.

11. The device for separating pouches defined by lines of perforations in a web as set forth in claim 9, wherein:
the pouch is not separated from the web when the first and second belts move at a substantially same speed.

12. The device for separating pouches defined by lines of perforations in a web as set forth in claim 9, further including:
a controller for selectively controlling speeds of the first and second belts;
wherein the controller selectively slows the speed of the first belt relative to the speed of the second belt by the predetermined threshold to separate the pouch; and
wherein the controller selectively sets the speed of the first belt to a substantially same speed of the second belt after the pouch is separated.

13. A method for separating pouches connected by lines of perforations in a string of inflated pouches, the method comprising:
selecting a number of inflated pouches;
counting inflated pouches from an end of the string of inflated pouches until the number of pouches is reached;
moving a set of inflated pouches having the selected number of inflated pouches to a separation location;
holding a remainder of the string of inflated pouches in a fixed position while advancing the set of inflated pouches, thereby separating the set of inflated pouches from the remainder of the string at the separation location.

14. The method of claim 13, further comprising:
waiting for a new number;
repeating the counting, moving and holding steps with the new number.

15. The method of claim 14, wherein an optical sensor and a controller are used to count the pouches from the end of the string of inflated pouches.

16. The method of claim 14, wherein a first stage of belts is used to hold the string of inflated pouches in a fixed position while a second stage of belts is used to advance the set of pouches.

17. A method for dispensing pouches connected by lines of perforations in a string of inflated pouches, the method comprising:
selecting a number of inflated pouches;
counting inflated pouches from an end of the string of inflated pouches until the number of pouches is reached;
moving a set of inflated pouches having the selected number of inflated pouches to a separation location;
holding a remainder of the string of inflated pouches in a fixed position at the separation location;
manually separating the set of inflated pouches from the remainder of the string of inflated pouches at the separation location;
detecting that the set of pouches has been separated from the remainder of the string of inflated pouches;
repeating the counting, moving, and holding steps.

18. The method of claim 17,
wherein an optical sensor and a controller are used to count the pouches from the end of the string of inflated pouches;
wherein a motion sensor and a controller are used to detect that the set of pouches has been separated from the remainder of the string of inflated pouches.
